(19) United States
(12) Patent Application Publication
(10) Pub. No.: US 2012/0088505 A1
(43) Pub. Date: Apr. 12, 2012

(54) BASE STATION CONTROLLER AND MOBILE TERMINAL

(75) Inventors: Hong Tat Toh, Singapore (SG); Hong Cheng, Singapore (SG); Takahisa Aoyama, Kanagawa (JP)

(73) Assignee: PANASONIC CORPORATION, Osaka (JP)

(21) Appl. No.: 13/376,806

(22) PCT Filed: Jun. 10, 2010
(86) PCT No.: PCT/JP2010/003858

§ 371 Date: Dec. 7, 2011

(30) Foreign Application Priority Data
Jun. 12, 2009 (JP) 2009-141662

(51) Int. Cl. H04W 8/00

(52) U.S. Cl. 455/434

(57) ABSTRACT

An HeNB-GW (120) is applied to a network that comprises a plurality of CSG cells, and comprises: an access-permitted CSG-ID list storing section (425) having a CSG identification of a CSG cell that a mobile terminal (140) is permitted to access stored therein; an HeNB information storing section having a PCI corresponding to the CSG cell identification stored therein; a location information receiving section (412) for receiving information identifying the location of the mobile terminal (140); a PCI mapping section (420) that reads at least one CSG cell accessible to the mobile terminal (140) from the access-permitted CSG-ID list storing section (425), reads, from the HeNB information storing section 430, a PCI of an adjacent CSG cell among the read CSG cells within a predetermined range of the CSG cell in which the mobile terminal (140) is present, and generates an accessible PCI list to the mobile terminal (140); and an HeNB managing section 410 for providing the mobile terminal (140) with the accessible PCI list. Therefore, a base station controller with which a mobile terminal can immediately be connected to a CSG cell that the mobile terminal is permitted to access may be provided.

### RELATED APPLICATION

The present application claims benefit of Japanese Patent Application No. 2009-141662, filed Jun. 12, 2009, the contents of which are hereby incorporated by reference.

### TECHNICAL FIELD

The present invention relates to a data communication network, and in particular to identification mobility management in a mobile communication system.

### BACKGROUND ART

In a mobile communication system (for example, Long Term Evolution, or LTE), a mobile terminal performs a handover from one cell to another to support mobility control. This type of mobility control must be addressed. The mobile control includes an inter-macro cell handover, inter-CSG (Closed Subscriber Group) cell handover, and a handover between a macro cell and a CSG cell. In the case of CSG cell, a base station such as a home base station (Home eNodeB, also referred to as HeNB hereinafter) may not have a direct interface (for example, X2 interface defined in [3GPP TS36.300]) with another base station or with a macro cell base station such as an eNodeB. In such a case, only an S1 handover may be achieved through a core network, i.e. a Mobility Management Entity (hereinafter referred to as MME).

In case of a radio link failure (hereinafter referred to as RLF), a mobile terminal will perform an RRC reestablishment procedure in an attempt to recover a connection. In case of the failure of the RRC reestablishment procedure, the mobile terminal will employ a Non Access Stratum (hereinafter referred to as NAS) recovery procedure.

### CITATION LIST

### Non-Patent Literature

Non-Patent Literature 1: 3GPP TS23.401 SAE
Non-Patent Literature 2: 3GPP TS36.331 RRC protocol
Non-Patent Literature 3: 3GPP TS36.304 IDLE mode
Non-Patent Literature 4: 3GPP TS24.301 NAS

### SUMMARY OF INVENTION

### Technical Problem

By the nature of CSG cell deployment, RLF is likely to occur during handover to a CSG cell at much higher rate than during handover to a regular macro cell, for reasons below. Due to its small coverage, a CSG cell needs to prepare itself for handover immediately in order to perform an uninterrupted handover. Without the X2 interface, however, a signal transmission delay may be usually increased between base stations, resulting in the inability of the mobile terminal to receive a handover command for initiating a handover. In addition, CSG access control processing may cause an additional handover preparation delay.

During RRC connection reestablishment processing, the mobile terminal may use an existing cell selection process to select an unprepared CSG, and as a result, may fail in reestablishing an RRC connection. This is because an RRC reestablishment procedure can be performed only on a prepared cell that has a user equipment (UE) context. Here, the UE context consists of UE security related information, UE service related information, UE RRC/RDCP/RLC/MAC settings, and the like.

In case of the failure of the RRC connection reestablishment, recovery processing by the NAS procedure is initiated. However, since the recovery processing by the NAS procedure may take time, the service may eventually be interrupted. For example, even when the mobile terminal selects a CSG cell that the mobile terminal is permitted to access in a CSG cell list, the cell may not have a UE context. This may occur because unless the base station to which the mobile terminal is connected is prepared so as to, for example, send a UE context to another base station, the other base station cannot have the UE context.

In order to address the problem, some techniques may be adopted. For example, the mobile terminal may be adapted to only select CSG cells that have previously been used. However, this may not ensure smooth handover, and previous CSG cells may not necessarily be suitable cells for RRC connection reestablishment.

The present invention has been made in view of such circumstances, and it is an object of the invention to provide a base station controller with which a mobile terminal can immediately be connected to a CSG cell that the mobile terminal is permitted to access.

### Solution to Problem

A base station controller according to the invention is a base station controller applied to a network that comprises a plurality of CSG cells, the base station controller comprising an access permission information storing section having a CSG identification of a CSG cell that a mobile terminal is permitted to access stored therein with the identification associated with the mobile terminal; a CSG cell information storing section having a physical cell ID corresponding to the CSG cell identification stored therein; a location information receiving section for receiving information identifying a CSG cell in which the mobile terminal is located; a mapping section that reads at least one CSG cell accessible to the mobile terminal from the access permission information storing section, reads, from the CSG cell information storing section, a physical cell ID of an adjacent CSG cell among the read CSG cells within a predetermined range of the CSG cell in which the mobile terminal is present, and generates an accessible physical cell ID list to the mobile terminal; and a notification section for providing the mobile terminal with the accessible physical cell ID list (hereinafter referred to as A-PCI list).

The base station controller can be implemented with different network elements depending on the network architecture. For example, (1) in a network comprising a control plane device (i.e. MME) of a core network and an HeNB-GW, the base station controller can be implemented with any one or both of the MME and the HeNB-GW. (2) In a network consisting of a control plane device (i.e. MME) of a core network and an HeNB of a CSG cell, the base station controller can be implemented with the MME.

### Advantageous Effects of Invention

According to the present invention, the mobile terminal can verify a CSG cell that the mobile terminal is permitted to access based on A-PCI list information without the need of receiving system information that includes a CSG identification. Therefore, it is advantageously possible to reduce time required for access verification of the mobile terminal.

As described herein, there are other embodiments of the invention. Therefore, the disclosure of the invention is intended to provide a part of the invention and is not intended to limit the scope of the invention as described and claimed herein.

### BRIEF DESCRIPTION OF DRAWINGS

FIG. 1 is a diagram showing operation of a mobile terminal acquiring an A-PCI list.

FIG. 2 is a diagram showing an architecture of a mobile communication system to which an embodiment of the invention may be applied.

FIG. 3A is a diagram showing an example of a table of CSG IDs of CSG cells that mobile terminals are permitted to access.

FIG. 3B is a diagram showing an example of a CSG-ID list.

FIG. 3C is a diagram showing a CSG-ID list narrowed down according to location information.

FIG. 3D is a diagram showing accessible physical cell IDs.

FIG. 4 is an operational sequence diagram of a mobile terminal using accessible PCI list parameters.

FIG. 5 is a diagram showing an example of an architecture of an MME.

FIG. 6 is a diagram showing operation of the MME to determine selected CSG IDs.

FIG. 7 is a diagram showing an example of an architecture of an HeNB-GW.

FIG. 8 is a diagram showing operation of the HeNB-GW to determine accessible PCI list parameters.

FIG. 9 is a diagram showing an example of an architecture of a mobile terminal.

FIG. 10 is a diagram showing operation of the mobile terminal to use accessible PCI list parameters.

FIG. 11 shows another example of a system architecture to which an embodiment of the invention may be applied.

FIG. 12 is an operational sequence diagram of the embodiment.

FIG. 13 is a diagram showing an example of an architecture of a MME.

FIG. 14 is a diagram showing an example of operation of the MME to determine accessible PCI list parameters.

FIG. 15A is a diagram showing an example of an A-PCI list.

FIG. 15B is a diagram showing another example of an A-PCI list.

FIG. 16 is a diagram showing an example of operation of the mobile terminal to determine whether a cell is ready or not.

FIG. 17 is a signal transmission sequence diagram of an embodiment in which a common accessible PCI list is used.

FIG. 18 is a diagram showing an example of operation of the mobile terminal to use a common accessible PCI list.

FIG. 19 is a diagram showing an example of operation of the mobile terminal to determine preferable notified CSG cell parameters.

FIG. 20 is an operational sequence diagram of a sixth embodiment.

FIG. 21 is an operational sequence diagram of operation in the case of M2M.

FIG. 22 is an operational sequence diagram of operation for creating A-PCI list information for each service and application to be used and providing it to a terminal.

FIG. 23 is an operational sequence diagram of operation for using information from a mobile terminal to restrict creation of multiple-A-PCI list information.

FIG. 24 is an operational sequence diagram of operation for using an A-PCI list in other applications than cell selection and cell reselection.

### DESCRIPTION OF EMBODIMENTS

The present invention will now be described in detail. Embodiments described herein are exemplary only and various modifications can be made to the present invention. Therefore, a specific configuration and functionality disclosed herein do not limit the scope of the claims.

A base station and a mobile terminal according to embodiments of the present invention will now be described below with reference to drawings.

### First Embodiment

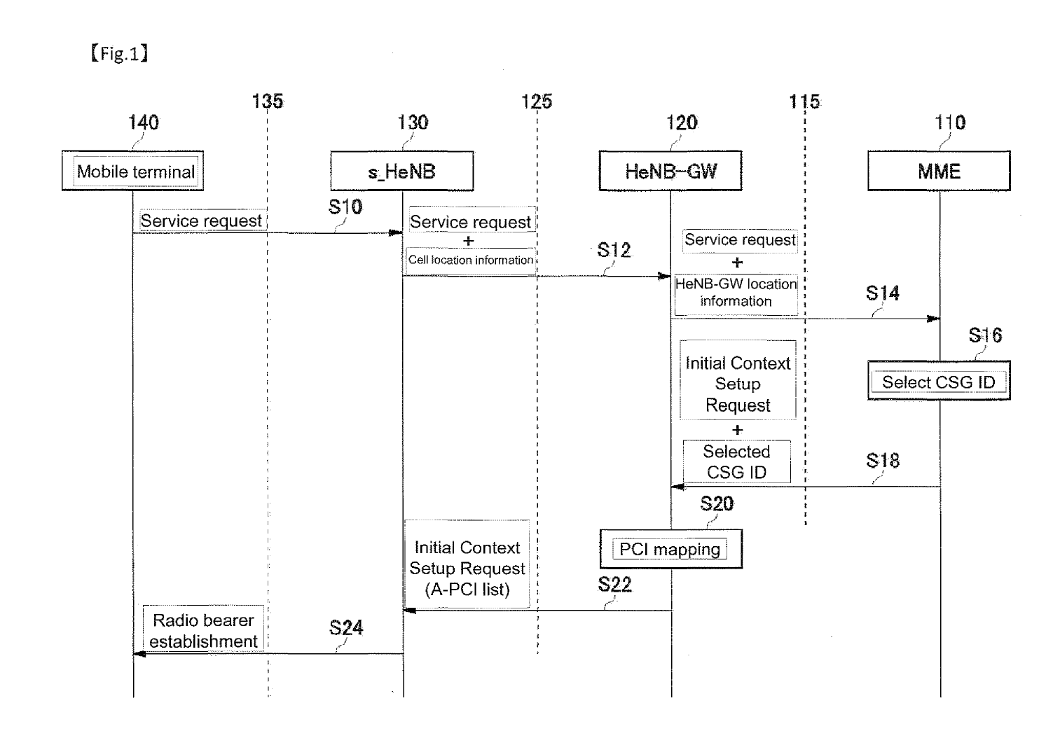

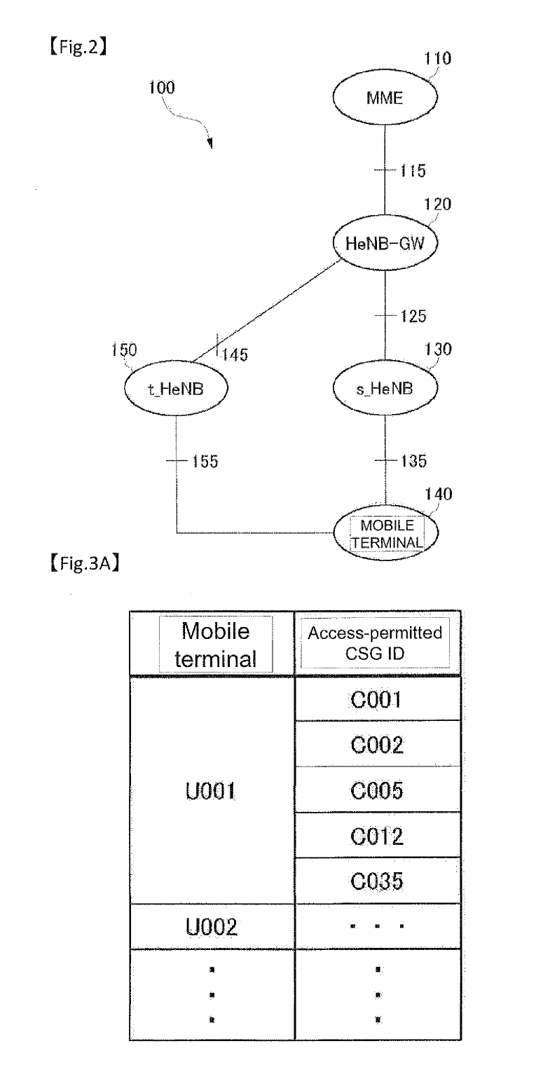

FIG. 1 is an operational sequence diagram of a mobile terminal 140 to acquire an A-PCI list during service session establishment processing. FIG. 2 is a diagram showing a mobile communication system 100 to which an embodiment of the invention may be applicable. The mobile communication system 100 will first be described with reference to FIG. 2.

The mobile communication system 100 comprises HeNBs 130 and 150 that provide CSG cells, and the mobile terminal 140 capable of communicating with the HeNBs 130 and 150 via interfaces 135 and 155. The HeNBs 130 and 150 are connected to a core network of a carrier, for example, another node such as MME 110, via an HeNB gateway (hereinafter referred to as HeNB-GW) 120. The HeNBs 130 and 150 are connected to the HeNB-GW 120 via interfaces 125 and 145, and are collectively controlled by the HeNB-GW. The MME 110 is connected to the HeNB-GW 120 via an interface 115. In this embodiment, the HeNB-GW 120 corresponds to the “base station”. Instead of connecting to the HeNBs 130 and 150 simultaneously, the mobile terminal 140 switches connection from the HeNB 130 via the interface 135 to the HeNB 150 via the interface 155, or vice versa.

As shown in FIG. 2, the mobile terminal 140 is initially in connection with the starting HeNB (hereinafter referred to as s_HeNB) 130 via the link 135. The s_HeNB 130 provides the mobile terminal 140 with services of the carrier via the HeNB-GW 120.

As for the control plane, the HeNB-GW 120 connects to the MME 110, which is a core network control element of the carrier. The MME 110 manages access control for the mobile terminal 140. In other words, the MME 110 determines which CSG cells of the CSG cell base stations the mobile terminal 140 is permitted to access. In some cases, there may be no HeNB-GW 120. In such a case, the HeNBs 130 and 150 connect to the MME 110 directly or via other elements.

With reference to FIG. 1, the operation of the mobile terminal 140 to acquire an A-PCI list will now be described. When the mobile terminal is in the range of the s_HeNB 130 and call connection processing is started, the mobile terminal transmits a service request similar to that defined in Non-Patent Literature 1 to the s_HeNB 130 (S10) to start a service session. Upon receiving the service request, the s_HeNB 130 selects a suitable MME 110 that matches with the mobile terminal 140. The s_HeNB 130 forwards the service request to the HeNB-GW 120 (S12) in order to send the service request to the selected MME 110. At this time, the s_HeNB 130 adds location information of the cell to the service request.

As will be apparent to those skilled in the art, there may be various forms of cell location information depending on implementations. For example, a form of cell location information may be global positioning system (GPS) parameters for the s_HeNB 130. The city location information given to the s_HeNB 130 or the global unique identifier of the cell such as ECGI may also be used as location information of the cell.

As will be apparent to those skilled in the art, the MME 110 may be selected by the HeNB-GW 120, instead of the s_HeNB 130. In this case, the s_HeNB 130 simply forwards the service request received from the mobile terminal 140 to the HeNB-GW 120, and the HeNB-GW 120 determines which MME 110 is suitable as a destination of the service request.

The HeNB-GW 120 replaces cell location information in the forwarded message with location information of the HeNB-GW 120. As location information of the HeNB-GW 120, regional information that can be recognized by the MME 110, such as a tracking area identifier (hereinafter referred to as TAI) may be used. Upon receiving the service request, the HeNB-GW 120 forwards the received service request to the corresponding MME 110 (S14). In the case where the MME 110 can directly interpret the cell location information added by the s_HeNB 130, the HeNB-GW 120 may transmit the information without replacement.

Depending on a scheme of CSG access control, the HeNB-GW 120 may verify the mobile terminal 140. In this case, when the HeNB-GW 120 determines that the mobile terminal 140 is not permitted to access the CSG cell, the HeNB-GW 120 returns an error message to the s_HeNB 130.

Upon receiving the service request, the MME 110 performs service control operation corresponding to that defined in Non-Patent Literature 1. The MME 110 also performs a test (access control for CSG) to check whether or not the mobile terminal 140 is permitted to access the cell based on the subscription status of the mobile terminal 140.

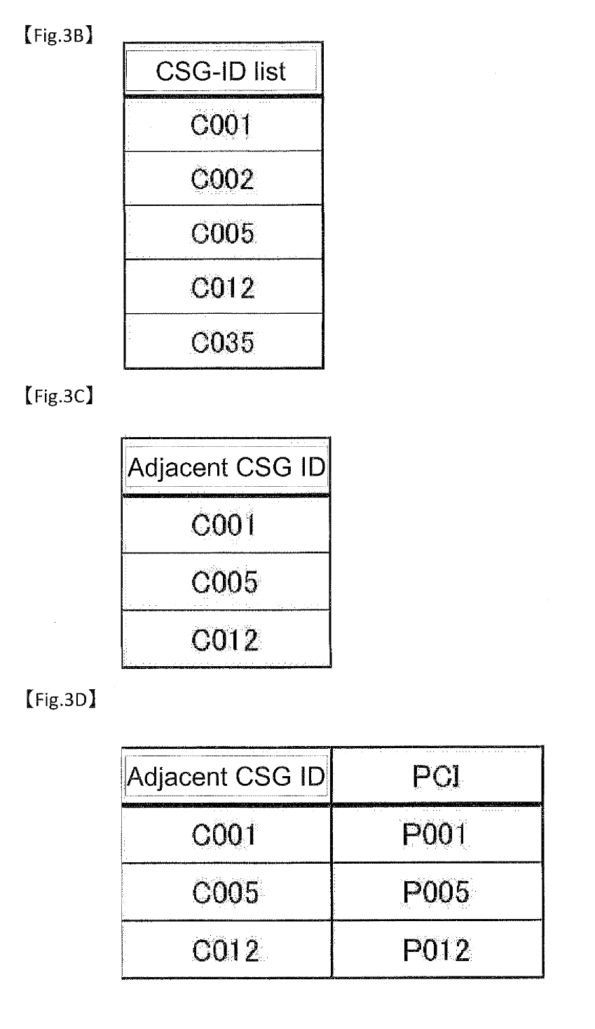

After such common operation, the MME 110 selects CSG IDs of CSG cells that the mobile terminal sending the service request is permitted to access (S16). FIG. 3A is a diagram showing an example of a table of CSG IDs of access-permitted CSG cells for each mobile terminal. The MME 110 reads a CSG-ID list corresponding to the mobile terminal 140 from the table. FIG. 3B is a diagram showing an example of a CSG-ID list of cells that the mobile terminal 140 having an ID “U001” is permitted to access.

The MME 110 transmits the selected CSG-ID list to the HeNB-GW 120 (S18) along with a response to the service request, such as Initial Context Setup Request. For example, the MME 110 transmits a list as shown in FIG. 3B corresponding to the mobile terminal 140 having an ID “U001”.

Upon receiving the selected CSG-ID list, the HeNB-GW 120 maps the CSG IDs to PCIs and generates an A-PCI list (S20). The A-PCI list is a list of Physical Cell Identifiers (hereinafter referred to as PCI) of CSG cells that the mobile terminal 140 is permitted to access. For example, when reception quality of the mobile terminal 140 is degraded, a UE context is passed by the s_HeNB 130 to a base station having a cell that is listed and under control, so that the base station can perform RRC reconnection processing.

Description will now be made to a detailed example of processing of the HeNB-GW 120 for PCI mapping. The HeNB-GW 120 performs PCI mapping based on information collected at various stages. Instead of selected CSG a cell global ID (CGI) list may be used to identify which cells the mobile terminal 140 is able to access.

For example, each of the HeNBs 130 and 150 provides the HeNB-GW 120 with CSG IDs supported by the HeNBs 130 and 150 for registration. The HeNB-GW 120 can thereby create a list of the CSG IDs and HeNBs 130 and 150 corresponding to the CSG IDs. At the same time, the HeNBs 130 and 150 also provide the HeNB-GW 120 with the corresponding location information. The HeNB-GW 120 stores the location information of the HeNBs 130 and 150.

The HeNB-GW 120 examines the information about the HeNBs 130 and 150 acquired as described above to retrieve HeNBs in the CSG-ID list indicated in the message transmitted from the MME 110. The HeNB-GW 120 further examines the location information to narrow the retrieved HeNBs down to HeNBs located near the mobile terminal 140. Whether or not an HeNB is near the current location of the mobile terminal 140 can be determined based on the location of the serving HeNB 130 for the mobile terminal 140. For example, information such as TAI or ECGI may be used as location information for the HeNB, or the HeNB-GW 120 may be adapted to retain GPS measurements of each HeNB. As will be apparent to those skilled in the art, the selection may also be made based, for example, on an inter-CSG relation, that is, whether or not the CSGs belong to the same high level group, or on a predefined roaming agreement of the carriers. FIG. 3C is a diagram showing a CSG-ID list obtained from the CSG-ID list shown in FIG. 3B narrowed down according to location information.

The HeNB-GW 120 next obtains PCIs of the selected HeNBs 130 and 150. FIG. 3D is a diagram showing physical cell IDs of base stations of CSG cells indicated in the CSG-ID list as shown in FIG. 3C. This is an A-PCI list. PCIs used by these HeNBs 130 and 150 are, for example, provided by the HeNBs 130 and 150 during HeNB registration processing and the HeNB-GW 120 may store the PCIs. If the HeNB-GW 120 lacks the PCIs, the HeNB-GW 120 interrogates these HeNBs 130 and 150 in an attempt to obtain the PCIs used. The A-PCI list may be composed of only PCIs without CSG IDs.

As will be apparent to those skilled in the art, there may be other possible ways of mapping the selected CSG-ID list to the A-PCI list. This in no way affects the general principle of the invention.

The HeNB-GW 120 transmits the A-PCI list to the s_HeNB 130 (S22) along with the forwarded Initial Context Setup Request. Upon receiving the Initial Context Setup Request, the s_HeNB 130 stores the A-PCI list and starts radio bearer establishment with the mobile terminal 140 as defined in Non-Patent Literature 2 (S24). In the radio bearer establishment, an RRC Connection Reconfiguration message as defined in Non-Patent Literature 2 may be used. The s_HeNB 130 inserts the A-PCI list into the radio bearer establishment message for the mobile terminal 140.

Upon receiving the radio bearer establishment message, the mobile terminal 140 stores the A-PCI list and performs operation required for the radio bearer establishment. The operation required for radio bearer establishment includes, for example, transmitting an RRC Connection Reconfiguration Complete message to the s_HeNB 130 as defined in Non-Patent Literature 2.

As will be apparent to those skilled in the art, the sequence described above does not show all steps, although the processing may involve other operation, such as that defined in the service request procedure by a UE in Non-Patent Literature 1. It will be apparent to those skilled in the art that these other operational steps in no way affect the general principle of the invention.

In the above description, a service request procedure initiated by the mobile terminal 140 is used to illustrate creation of an A-PCI list and transmission of the list to the mobile terminal 140. As another procedure, during communication while an “active” flag is set in a Tracking Area Update (TAU) message transmitted from the mobile terminal 140, the A-PCI list may also be created during tracking area update processing. The A-PCI list may be provided to the mobile terminal 140 when the “active” flag is not set.

The A-PCI list is related to a cell connected with the mobile terminal 140. It is therefore conceivable to update the A-PCI list at the time of handover and transmit the list to the mobile terminal 140 and the corresponding new HeNBs 130 and 150. The update processing can be started by a handover request message transmitted to the new HeNBs 130 and 150, and the A-PCI list can be updated and sent to the mobile terminal 140 by means of an RRC Connection Reconfiguration message, which indicates handover, as defined in Non-Patent Literature 2.

It will be apparent to those skilled in the art that, when new information on access-permitted CSG cells is notified from the network, the HeNB-GW 120 can create a new A-PCI list and provide the mobile terminal 140 with the list via the s HeNB 130. This can be accomplished as, for example, measurement configuration by means of an RRC Connection Reconfiguration message.

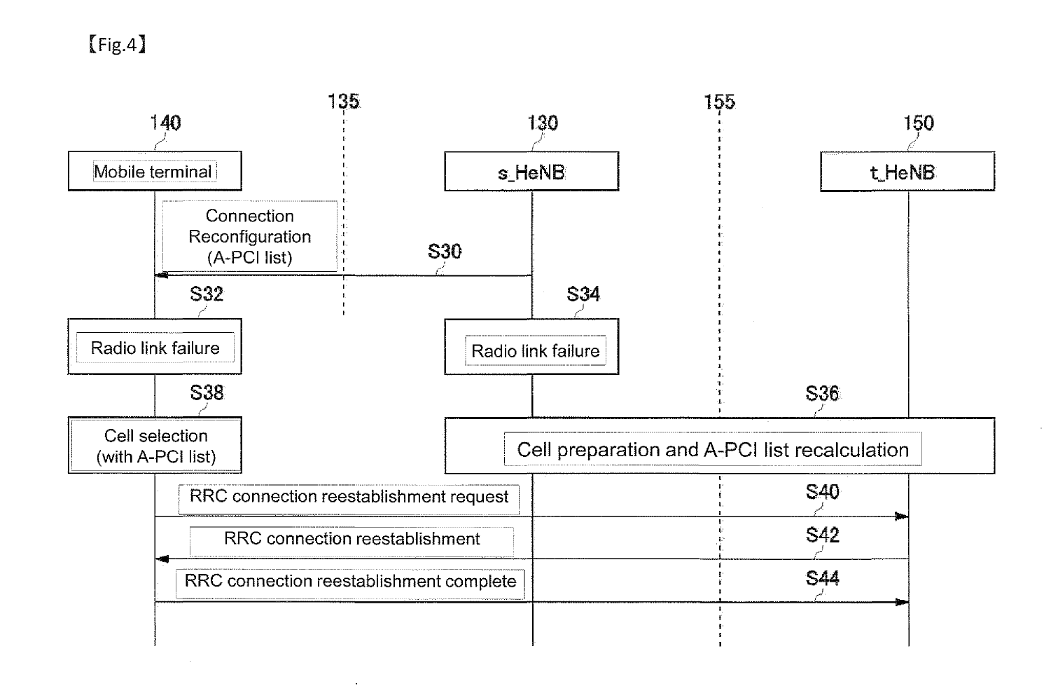

With reference to FIG. 4, description will be made to an operational sequence of the mobile terminal 140 to use an A-PCI list to recover a connection. As shown in FIG. 4, the s_HeNB 130 transmits the A-PCI list to the mobile terminal 140 by means of an RRC Connection Reconfiguration message (S30). The RRC Connection Reconfiguration message can be initiated by a service request, or may be started as part of measurement configuration by the s_HeNB 130.

Upon receiving the RRC Connection Reconfiguration message, the mobile terminal 140 stores the A-PCI list for later use. As will be apparent to those skilled in the art, the mobile terminal 140 may perform other necessary operation based on the received RRC Connection Reconfiguration message. However, this in no way affects the general principle of the invention.

Sometime later, the mobile terminal 140 detects a radio link failure. For example, the mobile terminal 140 exits the coverage of the s_HeNB 130 and enters that of the t_HeNB 150. In this case, if the mobile terminal 140 fails to recover the connection with the s_HeNB 130 within a predetermined period of time as defined in Non-Patent Literature 2, the mobile terminal 140 eventually detects the radio link failure (S32).

In this case, the mobile terminal 140 uses the A-PCI list acquired in step S30 to start a cell selection procedure. The mobile terminal 140 gives priority to cells in the A-PCI list for performing cell selection (S38).

In this example, since the A-PCI list includes a CSG cell of the t_HeNB 150, the mobile terminal 140 selects the t_HeNB 150 for RRC connection reestablishment, and performs an RRC connection reestablishment procedure as defined in Non-Patent Literature 2 (S40).

As will be apparent to those skilled in the art, in response to the RRC connection reestablishment request from the mobile terminal 140, the t_HeNB 150 can update the A-PCI list. The t_HeNB 150 may also perform the operation as part of cell preparation processing (S36). In this case, the t_HeNB 150 transmits a new A-PCI list to the mobile terminal 140 along with the RRC connection reestablishment message (S42).

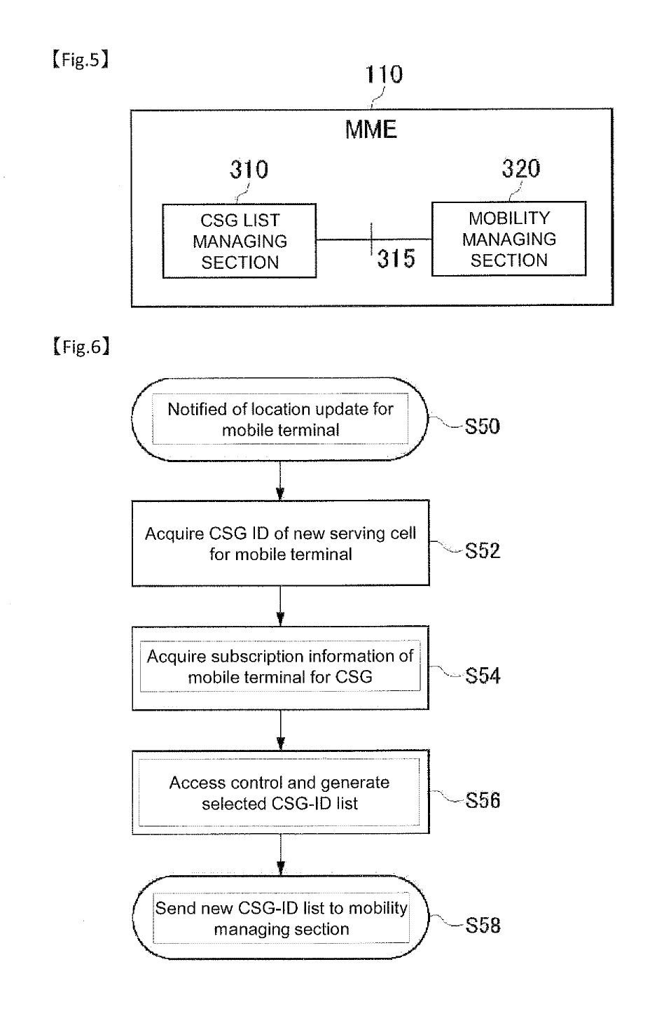

FIG. 5 is a diagram showing an architecture of the MME 110 that implements the invention. As shown in FIG. 5, the MME 110 has a CSG list managing section 310 and a mobility managing section 320.

The mobility managing section 320 processes mobility management related messages between the mobile terminal 140 and the MME 110. The protocol used between them is defined in Non-Patent Literature 4.

The CSG list managing section 310 performs access control for the mobile terminal 140 to a CSG cell. For example, once a NAS procedure is started by the mobile terminal 140 via a CSG cell, the mobility managing section 320 interrogates the CSG list managing section 310 whether the mobile terminal 140 is permitted to access the CSG cell based on a subscription profile such as that shown in FIG. 3A.

Meanwhile, the CSG list managing section 310 selects CSG-IDs of the CSG cells that the mobile terminal 140 is permitted to access. The CSG list managing section 310 outputs the selected CSG-ID list to the mobility managing section 320 via an interface 315. The mobility managing section 320 next forwards the selected CSG-ID list to the HeNB-GW 120 as shown in FIG. 1 (see FIG. 1, S18).

FIG. 6 is a diagram showing an example of operation of the CSG list managing section 310. As shown in FIG. 6, the CSG list managing section 310 is notified of location update for the mobile terminal 140 from the mobility managing section 320 (S50).

Upon detecting a serving cell change of the mobile terminal 140, for example, the mobility managing section 320 can notify the CSG list managing section 310 of it. In a campus or an office, for example, when the mobile terminal 140 changes its location without changing the CSG-ID of the serving cell, the same selected CSG-ID list may be reused because adjacent accessible CSG cells are changed. The operation of the mobility managing section 320 may differ depending on applications, and this in no way affects the general principle of the invention.

When the CSG list managing section 310 is notified of a location change of the mobile terminal 140, the CSG list managing section 310 attempt to acquire a CSG ID or a CGI of a new serving cell for the mobile terminal 140 (S52). Information such as of a new CSG-ID may be provided by the mobility managing section 320.

The CSG list managing section 310 further uses an access-permitted CSG list to acquire subscription information of the mobile terminal 140 (S54). The information is a part of the context of the mobile terminal 140 stored in the MME 110. If no subscription information is available, the MME 110 needs to acquire the subscription information from a core network of a carrier, for example, a subscription database of an HSS.

The CSG list managing section 310 next performs access control with respect to the CSG-ID of the new location of the mobile terminal 140, and generates a CSG-ID list of cells that the mobile terminal is permitted to access based on existing system information such as a roaming agreement or an inter-CSG-ID relation (S56).

The CSG list managing section 310 sends the new CSG-ID list to the mobility managing section 320 (S58). The mobility managing section 320 sends the CSG-ID list to the HeNB-GW 120 by means of an S1AP (S1 Application Protocol) message.

As will be apparent to those skilled in the art, the CSG list managing section 310 can take into consideration other information such as the location of the mobile terminal 140, time, loading condition of the system, and cost to access the system, at the time of generating the CSG-ID list.

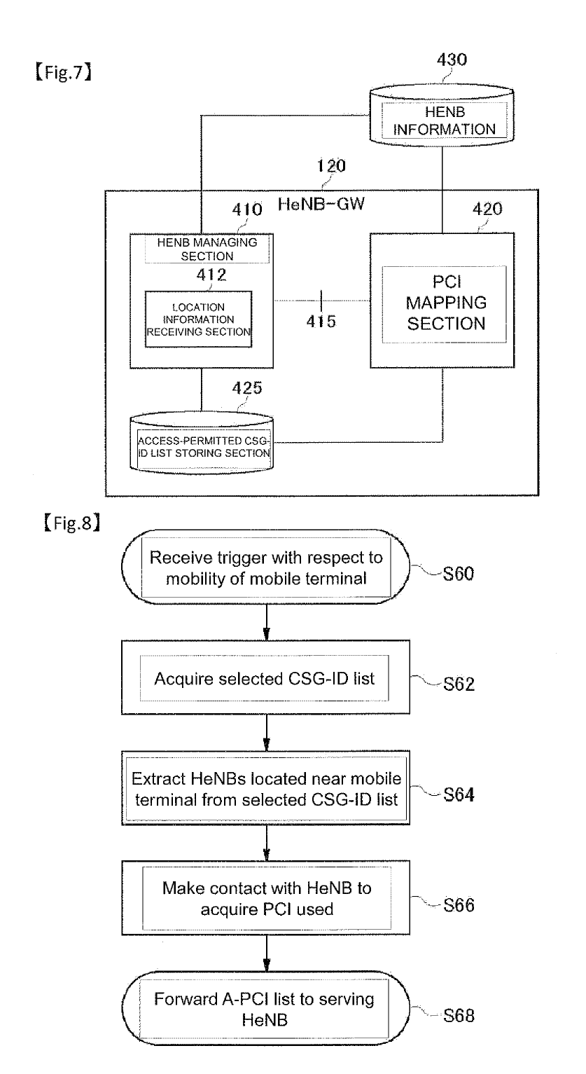

FIG. 7 is a diagram showing an example of an architecture of the HeNB-GW 120 according to an embodiment of the invention. As shown in FIG. 7, the HeNB-GW 120 comprises an HeNB managing section 410, a PCI mapping section 420, an access-permitted CSG-ID list storing section 425 for storing an access-permitted CSG-ID list received from the MME 110, and an HeNB information storing section 430 having data of the HeNBs 130 and 150 stored therein.

The HeNB managing section 410 manages connection of the HeNBs 130 and 150 with the MME 110. This involves registration and verification/authentication of the HeNBs 130 and 150, and establishment of an S1 interface between the HeNBs 130 and 150 and the MME 110. The HeNB managing section 410 can even intercept messages exchanged between the HeNBs 130 and 150 and the MME 110. The HeNB managing section 410 comprises a location information receiving section 412 for receiving cell location information of a cell in which the mobile terminal 140 is present from the HeNBs 130 and 150.

The PCI mapping section 420 narrows CSG cells in the CSG-ID list passed from the MME 110 down to accessible CSG cells to the mobile terminal 140 in the current location, and maps CSG-IDs of the narrowed CSG cells to PCIs. The PCI mapping section 420 performs the mapping based on information about the HeNBs 130 and 150 stored in the HeNB information storing section 430. In addition to physical cell IDs of the HeNBs 130 and 150 that are under control, the HeNB information storing section 430 has location information of the HeNBs 130 and 150, and the like.

If the information about the HeNBs 130 and 150 is not stored in the HeNB information storing section 430, the HeNB-GW 120 interrogates the HeNBs 130 and 150 corresponding to the HeNB-GW 120 on their PCIs.

FIG. 8 is a diagram showing an example of operation of the PCI mapping section 420 to map a selected CSG-ID list to a PCI list. As shown in FIG. 8, the PCI mapping section 420 receives a trigger with respect to mobility of the mobile terminal 140 (S60). The trigger may be generated by, for example, a new S1 Initial Context Setup Request from the MME 110, a handover related message incoming from the MME 110, or a handover related message within an HeNB.

Upon receiving the trigger, the PCI mapping section 420 acquires a CSG-ID list of the CSG cells that the mobile terminal 140 is permitted to access. The CSG-ID list is provided by the MME 110 as part of a message for mobility management of the mobile terminal 140.

The PCI mapping section 420 extracts HeNBs 130 and 150 located near the current location of the mobile terminal 140 among CSG cells in the selected CSG-ID list (S64). The HeNB location information used at this time can be obtained in HeNB registration processing with the HeNB-GW 120 and is stored in the HeNB information storing section 430. If the HeNB location information is not available, the HeNB-GW 120 can acquire the information through communication with the HeNBs 130 and 150.

For an HeNB, for example t_HeNB 150, that has been found to be near the mobile terminal 140, the PCI mapping section 420 acquires a PCI used for a cell corresponding to the CSG-ID. The PCI information has previously been acquired in HeNB registration processing and stored in the HeNB information storing section 430. Alternatively, the HeNB-GW 120 can acquire the PCI information by means of control functions (S66).

The PCI mapping section 420 passes a created A-PCI list to the HeNB managing section 410, and the HeNB managing section 410 forwards the A-PCI list to the s_HeNB 130 serving the mobile terminal 140 (S68).

As will be apparent to those skilled in the art, along with the A-PCI list, the HeNB-GW 120 can transmit other information such as a global unique identifier of an HeNB corresponding to a PCI in the list, for example, HeNB ID, ECGI, or the like as defined in Non-Patent Literature 1.

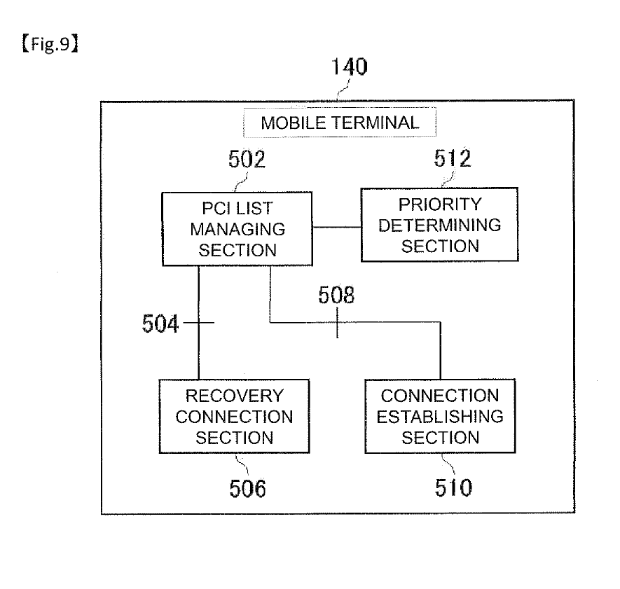

FIG. 9 is a diagram showing an architecture of the mobile terminal 140 according to an embodiment of the invention. As will be apparent to those skilled in the art, there are shown components necessary for illustrating the embodiment of the invention. This in no way excludes the possibility that the mobile terminal 140 comprises other components.

As shown in FIG. 9, the mobile terminal 140 comprises a PCI list managing section 502, a recovery connection section 506, a connection establishing section 510, and a priority determining section 512.

The PCI list managing section 502 stores physical cell identifications (PCI) of set adjacent cells and A-PCI list information. For example, when the s_HeNB 130 sets an A-PCI list and PCI information to the mobile terminal 140 by means of an RRC Connection Reconfiguration message, the PCI list managing section 502 stores the set A-PCI list and PCI information for later use. When the mobile terminal receives both adjacent cell PCIs and A-PCI list information from the s_HeNB 130, the information is supplied from the connection establishing section 510 to the PCI list managing section 502 via an interface 508. The recovery connection section 506 is then supplied with only the A-PCI list information from the PCI list managing section 502 through an interface 504.

The connection establishing section 510 performs an initial connection establishment procedure between the mobile terminal 140 and a network element (for example, s_HeNB 130). The protocol used between them is defined in Non-Patent Literature 2. Here, the connection establishing section 510 receives the A-PCI list information, physical cell identifications, and the like by means of, for example, an RRC Connection Reconfiguration message, and passes them to the PCI list managing section 502.

The recovery connection section 506 performs reestablishment processing between the mobile terminal 140 and an HeNB (for example, t_HeNB 150). This occurs when a radio link problem detected on the mobile terminal 140 continues beyond a predetermined time as defined in Non-Patent Literature 2. This is referred to as a radio link failure (RLF). If the RLF occurs, the mobile terminal 140 uses the A-PCI list information to perform a cell selection procedure.

The priority determining section 512 refers to the A-PCI list stored in the PCI list managing section 502 to determine HeNBs 130 and 150 that are given priority for quality measurement.

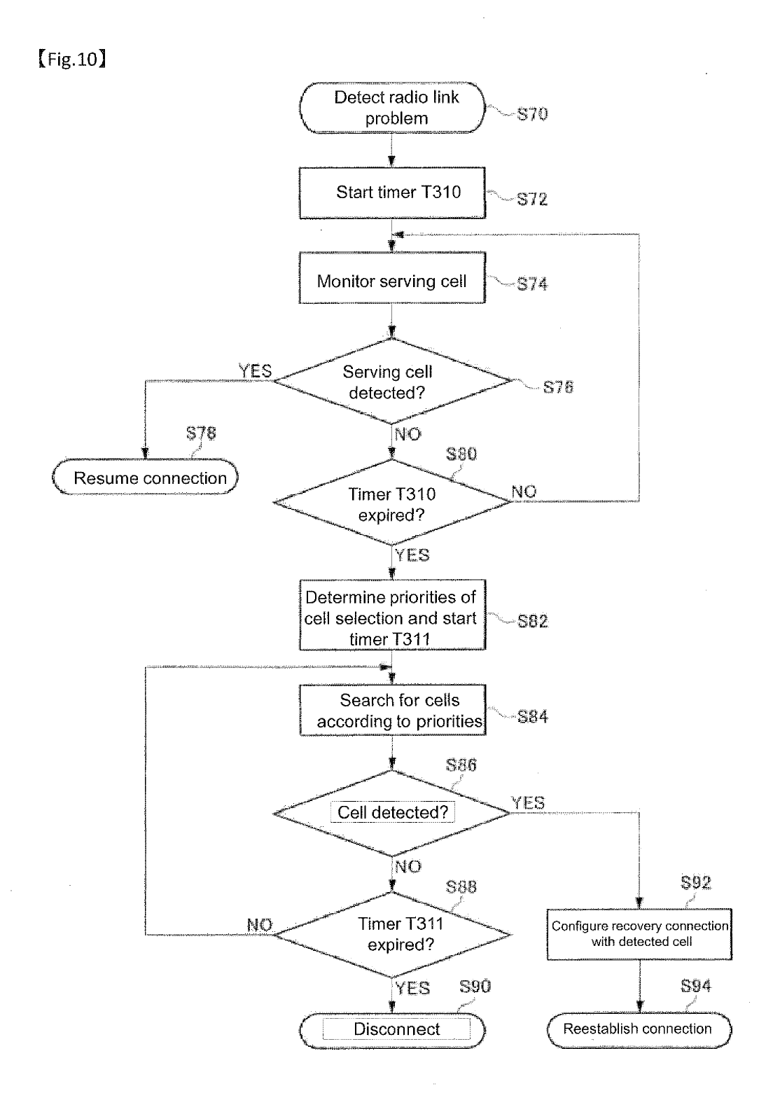

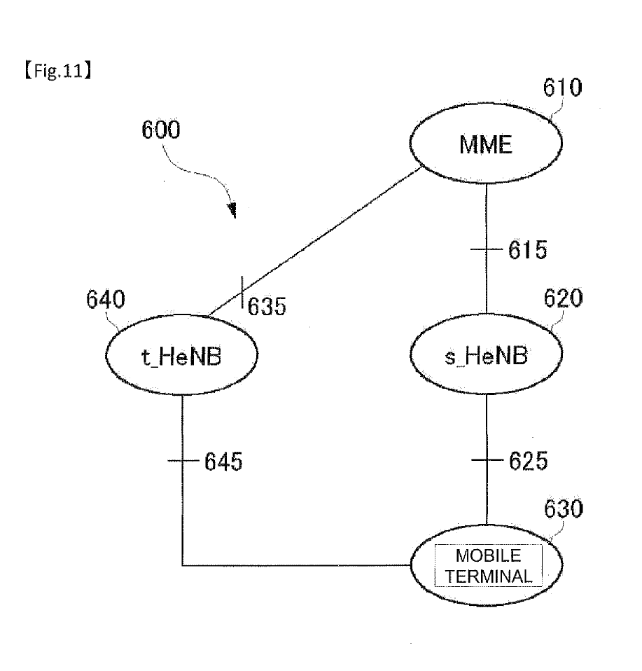

FIG. 10 is a diagram showing an example of operation of the mobile terminal 140. As will be apparent to those skilled in the art, there is shown as the operation only a part of mutual communication of the recovery connection section 506, which is a component of the mobile terminal 140, after the radio link problem is detected.

As shown in FIG. 10, the recovery connection section 506 of the mobile terminal 140 detects a radio link problem (S70). Upon detecting the radio link problem, the recovery connection section 506 starts a timer T310 (S72). While the timer T310 is running, the mobile terminal 140 attempts to detect the currently connected cell (S74). If the serving cell is detected (YES in S76), the mobile terminal 140 resumes the connection with the serving cell (S78).

If the serving cell is not detected (NO in S76), the mobile terminal 140 continues to search for the serving cell until the timer T310 expires (S74, S76 and S80). When the timer T310 expires (YES in S80), the mobile terminal 140 starts a timer T311, and determines priorities of cell selection by the use of A-PCI list information (S82). Here, the mobile terminal 140 determines priorities so that cells listed in the A-PCI list (hereinafter referred to as A-PCI cell) are searched for more frequently than other cells. The mobile terminal 140 then searches for cells according to the priorities (S84), and checks whether an adjacent cell is detected (S86).

If no cell is detected (NO in S86), the mobile terminal 140 continues searching until the timer T311 expires, putting a higher priority on A-PCI cells. Once the timer 311 expires (YES in S88), the mobile terminal 140 disconnects the serving cell (S90) and enters into an idle mode.

If a cell is detected (YES in S86), the mobile terminal 140 starts to configure a recovery connection with the detected cell (s92). The detected cell performs RRC connection reestablishment processing as defined in Non-Patent Literature 2. Upon completion of the reestablishment processing, the mobile terminal 140 resumes a service connection with the detected cell (S94). The configuration and operation of the HeNB-GW 120 according to the first embodiment have been described above.

Since the HeNB-GW 120 according to the first embodiment provides the mobile terminal 140 with an A-PCI list that shows PCIs of CSG cells that the mobile terminal 140 is permitted to access, the mobile terminal 140 can verify an accessible CSG cell without the need of receiving system information that includes a CSG identification. Therefore, it is possible to reduce time required for access verification of the mobile terminal 140.

In addition, the HeNB-GW 120 according to the first embodiment selects adjacent CSG cells among access-permitted CSG cells by the use of location information of the mobile terminal 140 to generate the A-PCI list. Since PCIs are not unique in a global sense, a same PCI may be assigned to different CSG cells, and it is therefore not possible to identify a CSG cell only with a PCI. In this embodiment, since the A-PCI list contains only CSG cells located near the mobile terminal 140 based on information of the current location of the mobile terminal 140, PCIs can be used to identify CSG cells. This has made it possible to provide faster accessibility decision based on PCIs.

In the above description, an example has been described in which, if no cell is detected, then A-PCI cells are given priority and continuously searched for. At this time, however, cells that are not listed in the A-PCI list may be searched for. For example, since a macro cell, if detected in the search, may retain a UE context, it may be possible to perform reconnection processing on the macro cell. Alternatively, it is possible at this time to include the macro cell that retains a UE context in the A-PCI list and to provide the mobile terminal 140 with the list.

In this embodiment, although description has been made to operation in the case where an A-PCI list is present, cases where no A-PCI list is configured may be conceivable. In other words, a mobile terminal may have only one CSG cell, for example a home base station. In the case of such a configuration where no A-PCI list information is present (i.e. A-PCI list=0), it is conceivable that the mobile terminal 140 gives priority to the macro cell over CSG cells in a cell selection procedure.

In this embodiment, description has been made to an example in which the MME 110 selects CSG cells that the mobile terminal 140 is permitted to access and transmits CSG IDs of the cells to the HeNB-GW 120, which selects CSG cells located near the location of the mobile terminal 140. Alternatively, the MME 110 may select CSG cell IDs of CSG cells located near the location of the mobile terminal 140 and transmit them to the HeNB-GW 120, which may convert the CSG IDs to physical cell IDs. In this case, both the MME 110 and the HeNB-GW 120 corresponds to the base station controller. In this way, functions of (1) selecting CSG cells that the mobile terminal 140 is permitted to access, (2) narrowing the selected CSG cells down to adjacent CSG cells, and (3) converting CSG IDs of the narrowed down CSG cells to PCIs can be allocated to network elements constituting the mobile communication system 100.

### Second Embodiment

FIG. 11 is a diagram showing a mobile communication system 600 according to a second embodiment. The basic configuration of the mobile communication system 600 is similar to that of the first embodiment, except that the HeNBs 620 and 640 are connected directly to an MME 610 without passing through a gateway function. In this embodiment, the MME 610 corresponds to the base station controller.

In this configuration, the HeNBs 620 and 640 provide the MME 610 with their configuration information, such as a supported CSG ID and location information. In the second embodiment, therefore, the MME 610 carries out operation performed by the HeNB-GW 120 in the first embodiment.

As will be apparent to those skilled in the art, although there are other core network elements such as a serving gateway that processes user plane data from the HeNBs 620 and 640 in an actual deployment, such elements are not shown for simplicity.

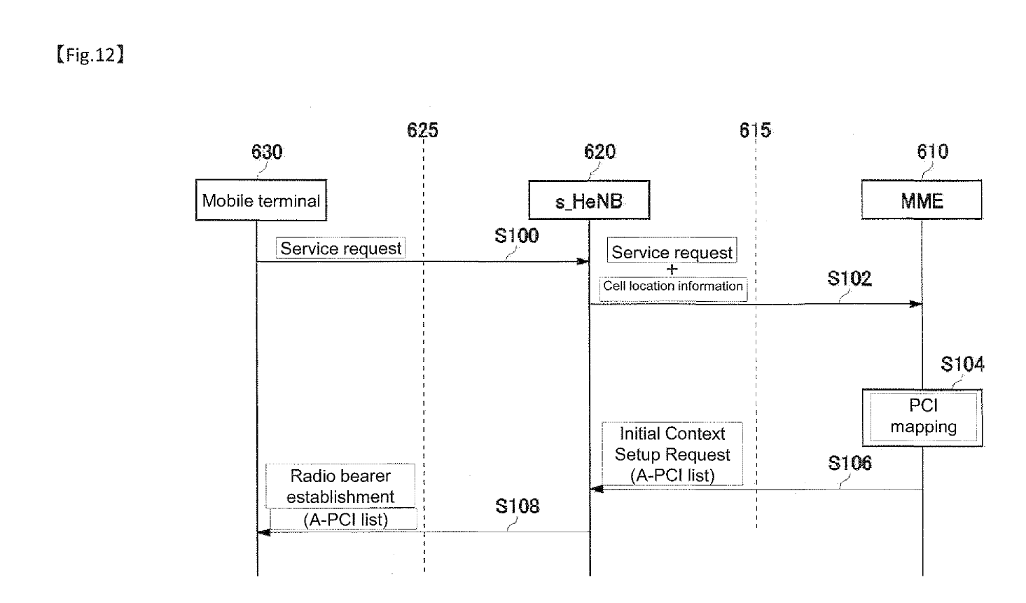

FIG. 12 is an example operational sequence of an architecture of the mobile communication system according to the second embodiment. As shown in FIG. 12, the mobile terminal 630 issues a service request when the terminal is in need of starting a service session in a CSG cell (s100).

Upon receiving the service request, the s_HeNB 620 selects a suitable MME 610 for serving the mobile terminal 630. Next, the s_HeNB 620 forwards the service request received from the mobile terminal 630 to the MME 610 along with location information of the CSG cell (S102). As will be apparent to those skilled in the art, there may be different types of location information depending on configurations or agreements between the MME 610 and the HeNBs 620 and 640.

Upon receiving the service request, the MME 610 performs necessary mobility management operation as defined in Non-Patent Literature 1. When a service session can be established, the MME 610 identifies adjacent CSG cells based on the current location of the mobile terminal 630, and performs PCI mapping to convert CSG IDs of the CSG cells to PCIs (S104). The PCI mapping generates an A-PCI list. The MME 610 forwards the A-PCI list to the s_HeNB 620 along with SI Initial Context Setup Request (S106).

Upon receiving the context setup request, the s_HeNB 620 starts radio bearer establishment (S108). The s_HeNB 620 transmits the A-PCI list to the mobile terminal 630 along with a radio bearer establishment message. The radio bearer establishment message may be an RRC Connection Reconfiguration message as defined in Non-Patent Literature 2.

As will be apparent to those skilled in the art, the description of the operation is intended to illustrate how the A-PCI list is generated and transmitted to the mobile terminal 630. To this end, other operational processing such as handover related processing via the MME 610 as defined in Non-Patent Literature 1 may also be used.

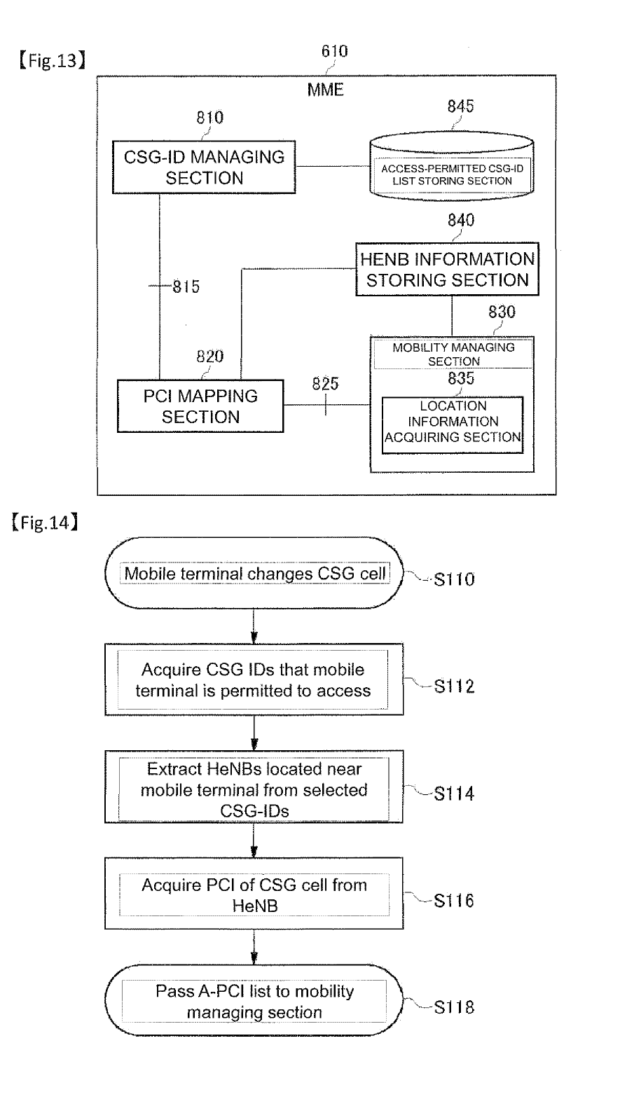

FIG. 13 is a diagram showing an example of an architecture of the MME 610 according to the embodiment. The MME 610 comprises a CSG-ID managing section 810, a PCI mapping section 820, a mobility managing section 830, an HeNB information storing section 840, and an access-permitted CSG-ID list storing section 845.

The mobility managing section 830 performs access control and mobility management for the mobile terminal 630. The mobility managing section 830 performs all necessary functions for the MME 610 as defined in Non-Patent Literature 1. In addition, the mobility managing section 830 comprises a location information receiving section 835 for receiving information about the location of the mobile terminal 630. The mobility managing section 830 also performs CSG related access control. For example, the mobility managing section 830 verifies whether or not the mobile terminal 630 is permitted to access a specific CSG cell with reference to a list stored in the access-permitted CSG-ID list storing section 845. When the mobile terminal 630 is successful in establishing a service session with a new CSG cell, or when the mobile terminal 630 is successful in changing the location in a connected mode, that is, successful in handover to another cell, the mobility managing section 830 sends a trigger to the PCI mapping section 820 via an interface 825.

The PCI mapping section 820 generates an A-PCI list corresponding to the current location of the mobile terminal 630. The PCI mapping section 820 acquires CSG-ID information required for mapping from the CSG-ID managing section 810, and acquires location information and PCIs of the HeNBs 620 and 640 from the HeNB information storing section 840.

The CSG-ID managing section 810 acquires and manages an access-permitted CSG-ID list of the mobile terminal 630. In response to a request from the PCI mapping section 820, the CSG-ID managing section 810 generates an access-permitted CSG-ID list and sends the list to the PCI mapping section 820 via an interface 815.

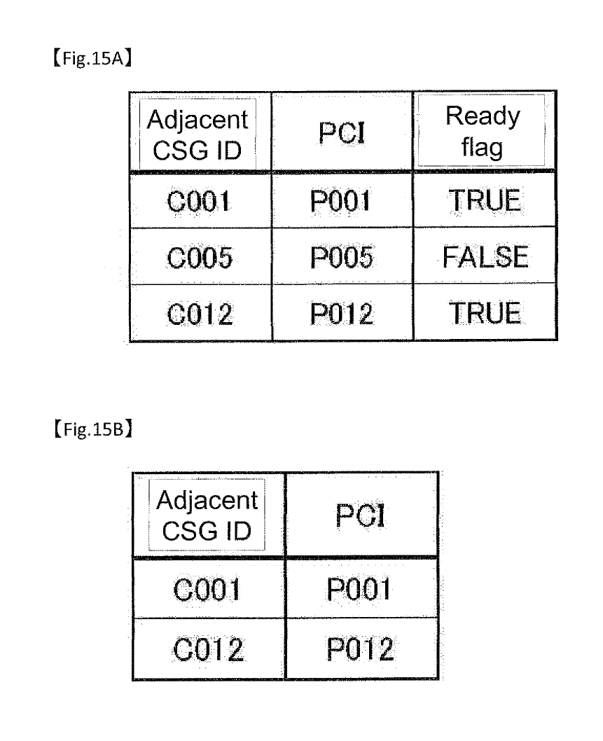

FIG. 14 is a diagram showing an example of operation of the PCI mapping section 820. When the mobile terminal 630 is successful in establishing a service session or a handover, the PCI mapping section 820 receives a trigger from the mobility managing section 830 (S110).

Upon receiving the trigger, the PCI mapping section 820 obtains a CSG-ID list from the CSG-ID managing section 810 (S112). The selected CSG-ID list is generated based on a subscription profile of the mobile terminal 630 and an inter-CSG-ID relation.

The PCI mapping section 820 checks for each CSG ID in the selected CSG-ID list whether there is any of HeNBs 620 and 640 located near the current location of the mobile terminal 630 (S114). The HeNB location information can be obtained in HeNB registration processing with the MME 610 and stored in the HeNB information storing section 840. If the HeNB location information is not available, the MME 610 can obtain the information through communication with the HeNBs 620 and 640 respectively.

For an HeNB, for example t_HeNB 640, that it is determined that the HeNB is near the mobile terminal 630, the PCI mapping section 820 acquires a PCI used for a cell corresponding to the CSG-ID. This information can also be acquired in advance in HeNB registration processing. Alternatively, the MME 610 can acquire the PCI information of the HeNBs 620 and 640 by means of control functions (S116).

The PCI mapping section 820 passes a created A-PCI list to the mobility managing section 830, and the mobility managing section 830 forwards the A-PCI list to a serving HeNB for the mobile terminal 630 (S118).

As will be apparent to those skilled in the art, along with the A-PCI list, the MME 610 can also transmit other information such as a global unique identifier of an HeNB corresponding to a PCI in the list, for example, HeNB ID, ECGI, or the like as defined in Non-Patent Literature 1.

Since the MME 610 according to the second embodiment provides the mobile terminal 630 with an A-PCI list that shows PC's of CSG cells that the mobile terminal 630 is permitted to access, the mobile terminal can verify an accessible CSG cell without the need of receiving system information that includes a CSG identification. Therefore, it is possible to reduce time required for access verification of the mobile terminal 630.

### Third Embodiment

CSG cells around s_HeNBs 130 and 620 prepare themselves for connection with the mobile terminals 140 and 630 for handover. Not all access-permitted CSG cells around the mobile terminals 140 and 630, however, are prepared by the s_HeNBs 130 and 620. In this embodiment, indication information indicating which PCI corresponds to a prepared cell is added to an A-PCI list. The indication information may be a flag associated with a PCI of the prepared cell, for example. A third embodiment will now be described with reference to the network architecture shown in FIG. 2 by way of example. The configuration described below, however, is also applicable to the network architecture shown in FIG. 11.

The s_HeNB 130 transmits a context of the mobile terminal 140 to adjacent HeNBs for connection preparation; cells of the adjacent HeNBs containing the context are the prepared cells for the mobile terminal 140. The s_HeNB 130 can, therefore, distinguish prepared cells and unprepared cells among the cells of adjacent HeNBs. The s_HeNB 130 transmits information on prepared cells or unprepared cells to the HeNB-GW 120. The HeNB-GW 120 generates an A-PCI list that contains information indicative of whether a cell is ready or not.

FIG. 15A is a diagram showing an example of an A-PCI list according to the embodiment. The A-PCI list according to the embodiment comprises a ready flag, in addition to IDs of adjacent CSGs and PCIs. When the ready flag is set to True, the CSG cell associated with the flag is a prepared cell. On the other hand, when the flag is set to False, the CSG cell associated with the flag is an unprepared cell.

The HeNB-GW 120 transmits the A-PCI list to the mobile terminal 140 by means of an RRC Connection Reconfiguration message as defined in Non-Patent Literature 2 during radio bearer establishment (see FIG. 1, S24).

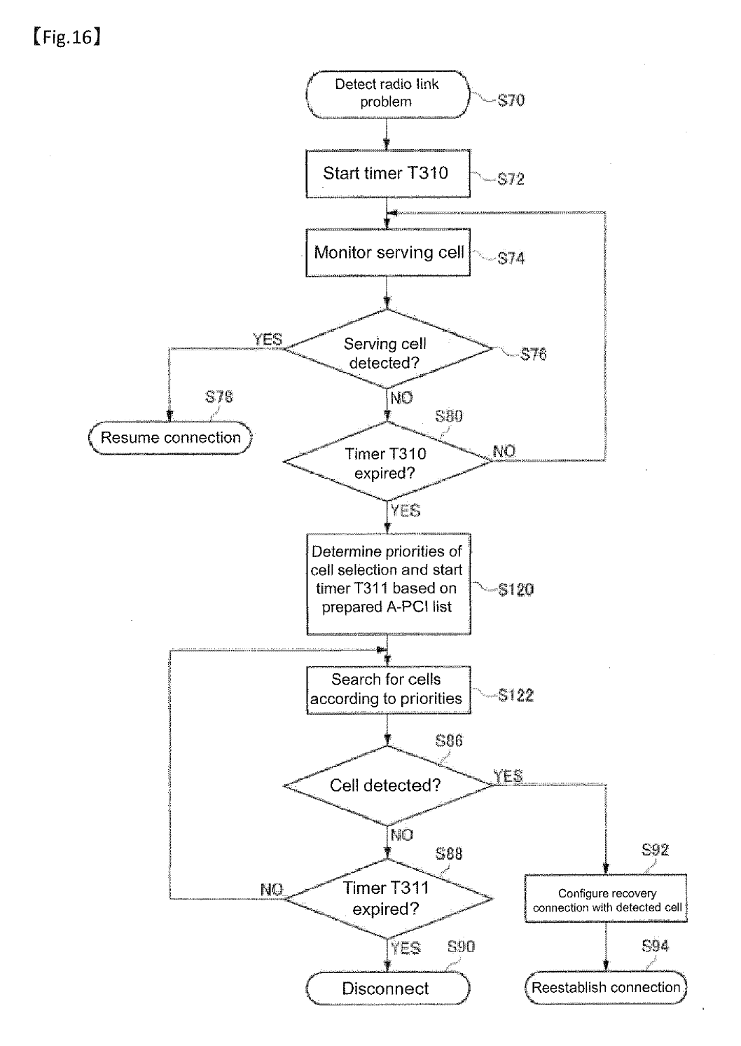

FIG. 16 is a diagram showing an example of operation in a procedure for recovering a connection at the mobile terminal 140 by the use of the created A-PCI list. Since the basic operation shown in FIG. 16 is similar to that of that shown in FIG. 10, the following description will be focused on main differences therebetween.

When the mobile terminal 140 encounters a radio link failure (YES in S80), the mobile terminal 140 determines priorities of cell selection by the use of A-PCI list information (S120). Specifically, priority is given to cells in a prepared A-PCI list over cells in an unprepared A-PCI list and other cells (for example, a macro cell). Based on the priorities, the mobile terminal 140 searches for cells in the prepared A-PCI list more frequently than other cells (S122). However, if there is only an unprepared A-PCI list (i.e. if all additional flags associated with the A-PCI list are set to False), the mobile terminal 140 gives priority to a macro cell over cells in the unprepared A-PCI list in a cell selection procedure. The base station controller and the mobile terminal according to the third embodiment have been described above.

In the third embodiment, the mobile terminal 140 can select a prepared CSG cell accessible to the mobile terminal 140 during an RRC reestablishment procedure so as to avoid a connection failure due to unpreparedness.

In the above embodiment, description has been made to an example in which there is provided a ready flag indicative of whether a cell is ready or not. However, an A-PCI list that contains only prepared CSG cells may be generated. FIG. 15B is a diagram showing another example of an A-PCI list in the same state of preparedness as the A-PCI list shown in FIG. 15A. In this example, information of unprepared CSG cells has been deleted as a whole record. With this A-PCI list, the mobile terminal 140 can also select a prepared CSG cell. The A-PCI list has an advantage that the amount of information can be reduced.

In this embodiment, although an example has been described in which the s_HeNB 130 distinguishes prepared cells and unprepared cells, this can be done by the HeNB-GW 120. In this case, the A-PCI list shown in FIG. 15A or 15B is created by the HeNB-GW 120.

### Fourth Embodiment

In a fourth embodiment, description will be made to applications to a network configuration in which A-PCI list information is broadcast to mobile terminals 140, such as when deployed in an enterprise network. The fourth embodiment will now be described with reference to the network architecture shown in FIG. 2 by way of example. However, the configuration described below may be applicable to the network architecture shown in FIG. 11.

In a deployment environment comprising more than one HeNB such as in an office or a school premise, for example, when services are provided to users such as employees or students, the A-PCI list information may be useful to all employees or all students. In such a case, a network element (for example, HeNB) can broadcast common A-PCI list information to mobile terminals 140 as broadcast information.

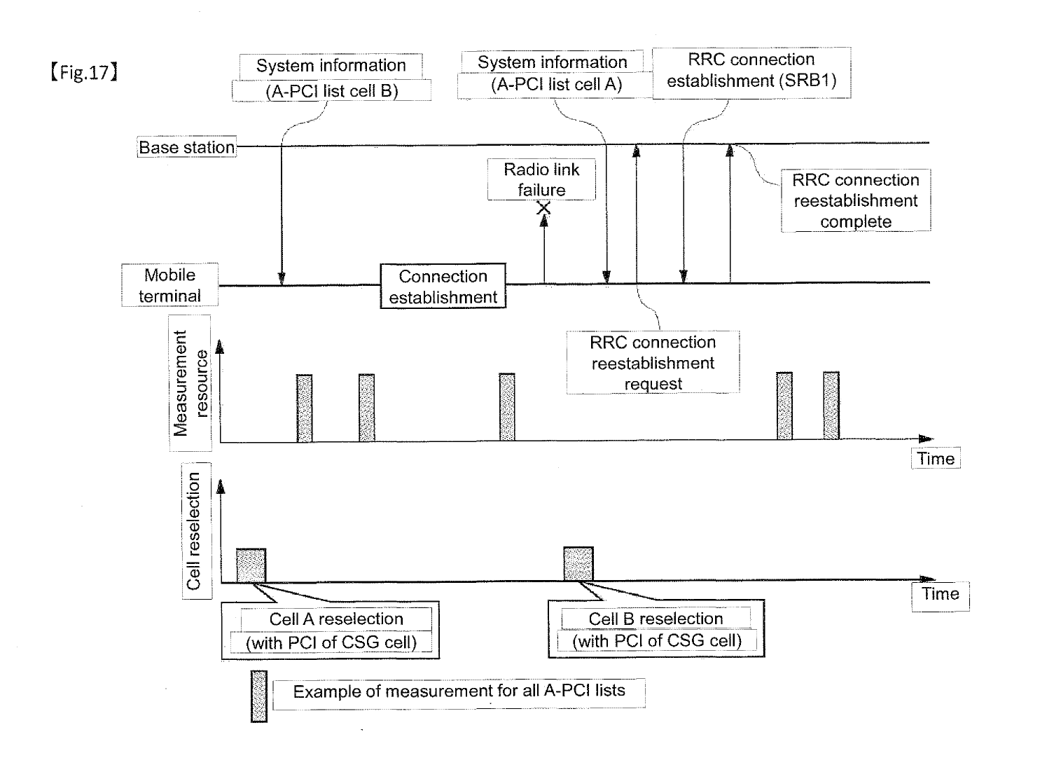

The PCI mapping section 420 operating in the HeNB-GW 120 generates A-PCI list information common to multiple mobile terminals 140. The settings of the common A-PCI list may be determined by the carrier operating the CSG cell or the owner. For example, when a carrier frequency dedicated to CSGs is used, the carrier can use system information as defined in Non-Patent Literature 2 to broadcast common A-PCI list information to mobile terminals 140 from a base station (s_HeNB 130) as shown in FIG. 17.

The mobile terminal 140 will be described with reference to FIG. 9. Upon obtaining common A-PCI list information via the connection establishing section 510, the mobile terminal 140 stores the common A-PCI list information in the PCI list managing section 502. The mobile terminal 140 can use the common A-PCI list information in the recovery connection section 506.

The priority determining section 512 of the mobile terminal 140 determines priorities in searching for cells so that priority is given to cells in a common A-PCI list over other cells (for example, a macro cell). For example, CSG cells located in the coverage of a macro cell are given priority.

The recovery connection section 506 searches for cells in a cell reselection procedure or a cell selection procedure according to the priorities determined in the priority determining section 512.

According to the embodiment, since a common A-PCI list is broadcast, the number of transmission of dedicated signals can be reduced and mobility of mobile terminals in an idle mode can be improved.

Whether the common A-PCI list is valid or not can be determined based on the location of the mobile terminal 140. For example, when the mobile terminal 140 moves to another cell that is in the same HeNB deployment environment (for example, a CSG cell located in an office of a company or a school premise) after re-establishment, the mobile terminal 140 can continue using the common A-PCI list information. The common A-PCI list information can be changed by the s_HeNBs 130 and 620 using a system information message as defined in Non-Patent Literature 2.

In the case of a deployment environment comprising more than one HeNB (i.e. in an office or a school premise), providing information on all CSG cells to mobile terminals 140 in one common control signal may be complicated. In order to alleviate the problem, one possible way is that CSG cells may be divided into different groups. For example, an associated parameter such as a group PCI ID may be set along with common A-PCI list information. The associated parameter is broadcast along with the common A-PCI list information. When new common A-PCI list information is available, the s_HeNB 130 broadcasts an updated group PCI ID to mobile terminals 140 along with the A-PCI list information. In response to receiving the updated group PCI ID, mobile terminals 140 consider A-PCI list information currently stored to be invalid, and store the new A-PCI list information for later use. On the other hand, when mobile terminals 140 receive the same group PCI ID, the mobile terminals 140 can determine that the previously received common A-PCI list information can still be used. As will be apparent to those skilled in the art, mobile terminals 140 can perform other operation required for acquiring updated common A-PCI list information for the group of CSG cells. This in no way affects the general principle of the invention.

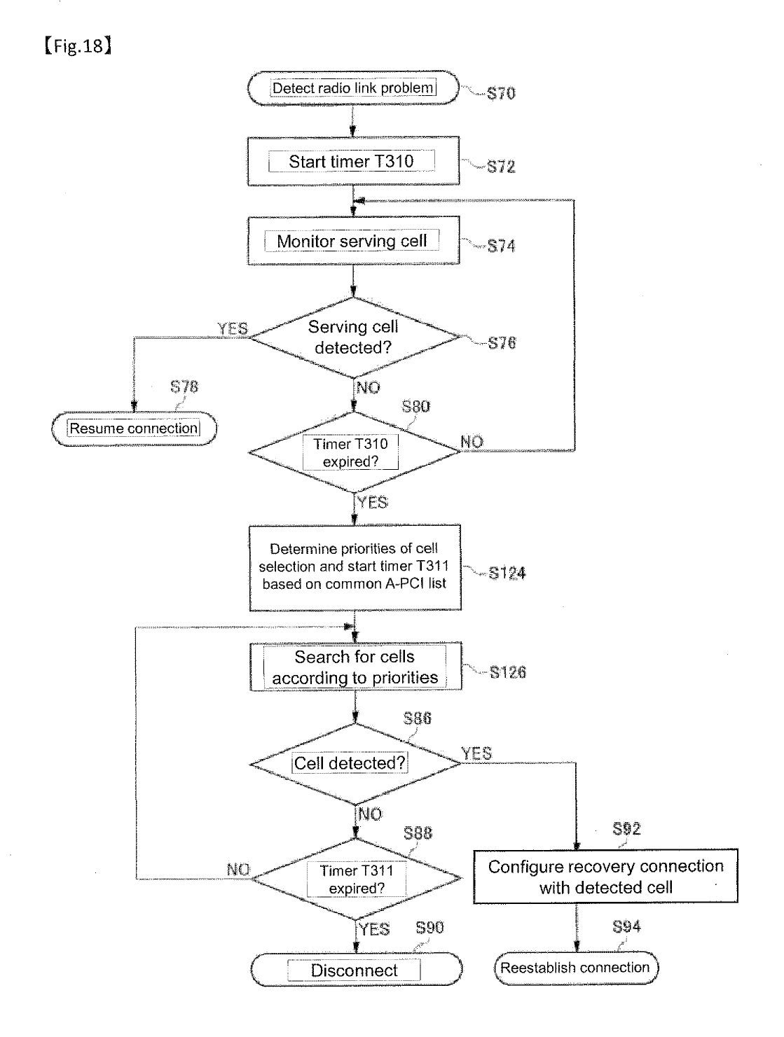

FIG. 18 is a diagram showing an example of the mobile terminal 140 using common A-PCI list information to perform a re-establishment procedure. Since the basic operation shown in FIG. 18 is similar to that of that shown in FIG. 10, the following description will be focused on main differences therebetween.

When the mobile terminal 140 encounters a radio link failure (YES in S80), the mobile terminal 140 determines priorities so that cells in a common A-PCI list are given priority and searched for over other cells (for example, a macro cell) (S124). With this cell selection prioritization, the mobile terminal 140 searches for cells in the common. A-PCI list more frequently than other cells (S126). For example, in cell selection, the mobile terminal 140 using the common A-PCI list puts a higher priority only on accessible CSG cells in the same HeNB deployment environment (for example, CSG cells located in an office of a company or a school premise) over other CSG cells that are not in the same HeNB deployment environment or macro cells. The purpose of putting a higher priority on cells that are listed in the common A-PCI list in a cell selection procedure is to enable the mobile terminal 140 to stay in the same HeNB deployment environment (i.e. CSG cells located in an office of a company or a school premise) after the re-establishment procedure. The mobile terminal 140 can thereby continue to take advantage of a special service (for example, higher data rate) from a selected accessible CSG cell.

### Fifth Embodiment

In a fifth embodiment, description will be made to an example in which, in order to assist the s_HeNB 130 in determining a handover, the mobile terminal 140 uses information on accessible CSG cells to make notification to the s_HeNB 130. The fifth embodiment will now be described with reference to the network architecture shown in FIG. 2 by way of example. However, the configuration described below may be applicable to the network architecture shown in FIG. 11.

Based on A-PCI list information, the mobile terminal 140 acquires a preferable CSG cell as a handover destination. Such a preferable CSG cell as a handover destination is a CSG cell that the mobile terminal is permitted to access, and a prepared cell if it is possible to distinguish whether the cell is ready or not. Referring to FIG. 9, the connection establishing section 510 in the mobile terminal 140 evaluates cells in A-PCI list information, and uses an existing RRC message, such as a measurement report, to notify preferable, accessible CSG cells to the s_HeNB 130.

The s_HeNB 130 can thereby notice cells intended by the mobile terminal 140 (i.e. candidate cells preferable as a handover destination). In this case, the s_HeNB 130 can give priority to the preferable cells in a handover preparation procedure.

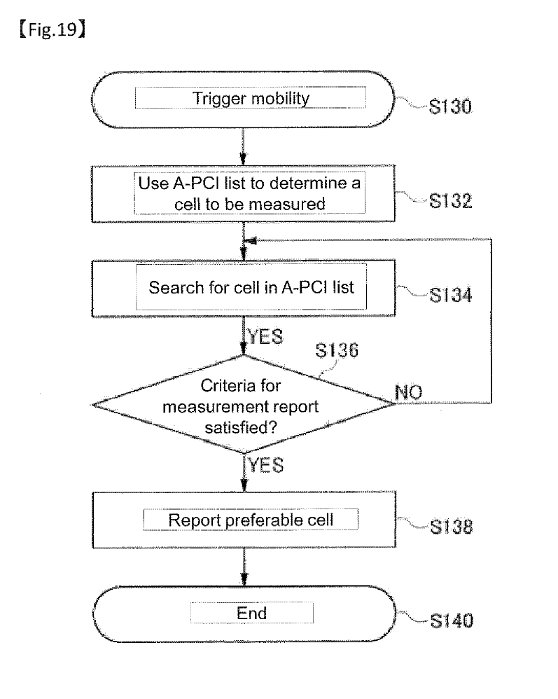

FIG. 19 is a diagram showing an example of operation of the mobile terminal 140 in a connection establishment procedure to determine preferable, accessible CSG cells, with A-PCI list information notified.

As shown in FIG. 19, when mobility is triggered due to degradation of reception quality or the like (S130), the connection establishing section 510 of the mobile terminal 140 uses A-PCI list information to determine a cell to be measured (S132). The mobile terminal 140 searches for the cell determined to be measured (S134). The mobile terminal 140 checks whether or not criteria for transmitting a measurement report are satisfied.

If the notification criteria are not satisfied (NO in S136), the mobile terminal 140 continues searching for and measuring cells listed in the A-PCI list. If the notification criteria are satisfied (YES in S136), the mobile terminal 140 uses an existing RRC message, such as a measurement report message, to transmit measurement results based on the notification criteria (S138). Since cells in the A-PCI list are measured, the measurement results notified here are those of the preferable CSG cells that the mobile terminal 140 is permitted to access.

It is to be noted that measurement results based on notification criteria are those of, for example, cells that satisfy the notification criteria. More specifically, if a cell that has a better quality than the currently connected cell satisfies the notification criteria, the quality result of the cell that has a better quality than the currently connected cell is transmitted along with the identifier of the cell (PCI). Upon completion of the evaluation notification, the mobile terminal 140 stops the evaluation procedure (S140).

In the above description, an example has been described in which a terminal selects only cells that are included in an A-PCI list as subjects for notification criteria. It is however possible to subject all cells to notification criteria and separately notify of cells included in the A-PCI list in a measurement report. This is useful when an A-PCI list is only provided to equipment included in an operator such as an MME and an HeNB-GW as well as terminals, while the list is not provided to HeNBs. It is the case that, for example, an HeNB transmits an A-PCI list generated by an MME or an HeNB-GW to a mobile terminal without using any decodable messages. At this time, the base station cannot determine which cell is accessible based only on a PCI. The mobile terminal, however, can notice a CSG cell to which the terminal can be handed over, that is, a CSG cell that has good measurement quality and access permission, from a measurement result and an A-PCI list. Communicating this to the base station enables the base station to make an appropriate decision on handover operation.

Referring to FIG. 19, when the mobile terminal 140 transmits a measurement report message to the s_HeNB 130 (S120), the mobile terminal 140 incorporates an additional flag indicative of whether or not a notified physical cell identification (PCI) is accessible into the measurement report message. The additional flag set to TRUE indicates that the PCI associated with the flag is that of a preferable, accessible CSG cell. On the other hand, when the additional flag is set to FALSE, the base station can determine that the PCI associated with the flag is not that of a preferable, accessible CSG cell.

As will be apparent to those skilled in the art, the mobile terminal 140 may perform other necessary operation for configuring a measurement report message. However, this in no way affects the general principle of the invention.

The purpose of setting and notifying preferable, accessible CSG cells is to enable the mobile terminal 140 to assist the s_HeNB 130 in determining a handover so that the mobile terminal 140 can still stay in an accessible CSG cell after a handover procedure. The mobile terminal 140 can thereby continue to take advantage of a special service (for example, higher data rate service) from an accessible CSG cell to which the terminal is connected.

Since the base station uses preferable CSG cell information notified from the mobile terminal 140 to perform a handover, the base station does not need to interrogate the MME 110 whether the mobile terminal 140 is permitted to access the CSG cell for verification, and the mobile terminal 140 can immediately be handed over. In addition, when both a CSG cell and a macro cell are located near the serving cell, the mobile terminal can be handed over to an access-permitted CSG cell without the need of always performing a handover to the macro cell.

Embodiments of the mobile communication system according to the invention have been described above in detail. However, the preset invention is not limited to the embodiments as described above.

In the above description with reference to FIG. 11, description has been made to an example in which the s_HeNB 620 uses A-PCI list information to determine PCIs of CSG cells accessible to the mobile terminal 630. However, the HeNB 620 may be replaced with an eNodeB (i.e. macro cell).

Upon receiving A-PCI list information, the eNB uses the information to perform a preparation procedure for handover to an accessible CSG cell. For example, after the eNB receives a measurement report message, the eNB uses a notified PCI to determine which PCI is that of an accessible CSG cell (this means that the eNB uses an A-PCI list stored therein for verification). This can help the eNB to increase the possibility of the mobile terminal 630 to be handed over to an accessible CSG cell.

The base station (eNB) can therefore use A-PCI list information to perform a preparation procedure for handover to an accessible CSG cell.

### Sixth Embodiment

In this embodiment, description will be made to an example in which A-PCI list information in the above embodiments is created in consideration of not only information of whether the mobile terminal is permitted to access a CSG cell but also other conditions such as services provided.

One of services provided by an HeNB is Local IP Access (LIPA). This is a technology that allows a mobile terminal to connect to equipment, such as a video recorder or a printer, in a customer's premise via an HeNB, and is characterized by the fact that communication can be made from the mobile terminal through the HeNB to the home equipment and therefore without the need of passing through an operator network. When the Local IP Access technology is applied to an office or the like, it is considered that there may be more than one HeNB. In such a case, when the mobile terminal is in communication with equipment, such as a video recorder or a printer, via Local IP Access, it is conceivable to provide the mobile terminal with cells that allow the terminal to continue the Local IP Access as an A-PCI list. It is therefore possible to preferentially select a cell that allows the mobile terminal to continue the Local IP Access.

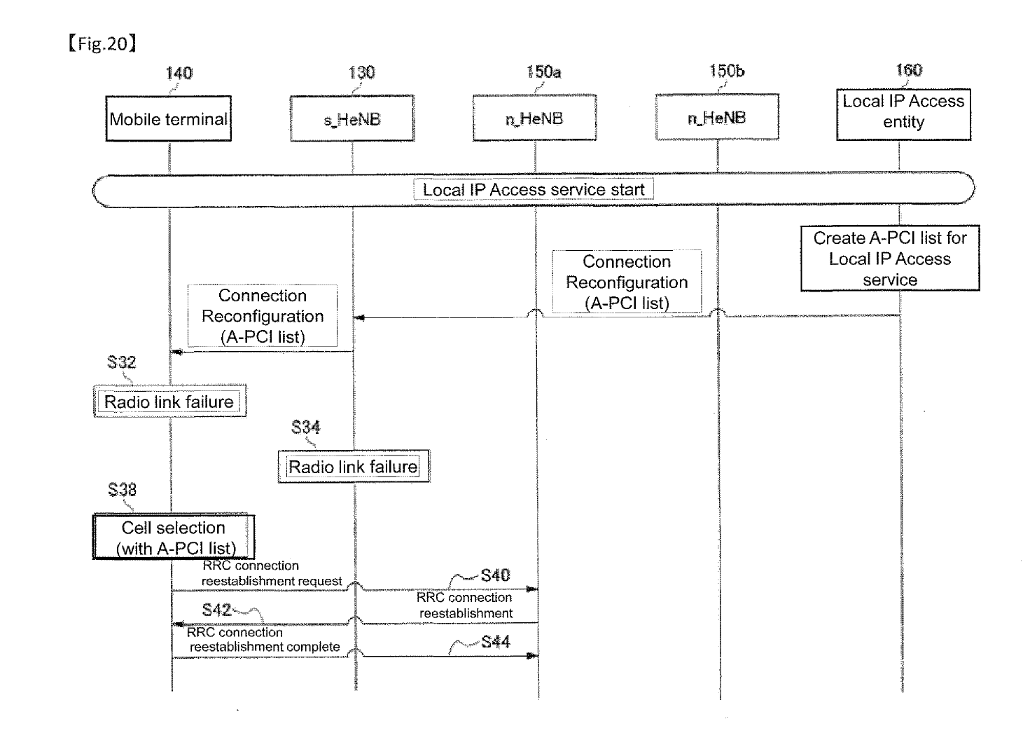

FIG. 20 shows an operational sequence of the operation. The diagram is based on FIG. 4, and description on similar portions to those in FIG. 4 will be omitted.

Both n_HeNBs 150a and 150b are adjacent HeNBs to the s_HeNB 130, and in this example, the n_HeNB 150a corresponds to an HeNB that provides a cell included in an A-PCI list and the n_HeNB 150b corresponds to an HeNB that provides a cell that is not included in an A-PCI list.

A Local IP Access entity 160 is an entity for providing and managing services of the Local IP Access, which creates an A-PCI list (including cells provided by the n_HeNB 150a) for use in the Local IP Access services and transmits it to the s_HeNB 130. The s_HeNB 130 provides the mobile terminal 140 with the A-PCI list.

In this way, with the operation shown in FIG. 20, the mobile terminal 140 can be notified of cells that can provide the Local IP Access, and as a result, the mobile terminal 140 can preferentially select cells provided by the n_HeNB 150a to continue the Local IP Access that the mobile terminal 140 has used with the s_HeNB 130.

In FIG. 20, although description has been made to an example in which the Local IP Access entity 160 is used as an entity for providing and managing services of the Local IP Access, this function may be implemented in an HeNB, may be a Local Gateway (Local GW, L-GW) as defined in Non-Patent Literature (3GPP TR23.829 V1.0.1), may be in an HeNB-GW, or may be provided in an MME.

Alternatively, the location of the mobile terminal 140 and information about services to be used can be used in creating an A-PCI list.

In the above example, description has been made to the case where a list is created for cells that the mobile terminal 140 should access or that is accessible to the mobile terminal 140 as an A-PCI list. However, it is otherwise possible to create a list of cells that the mobile terminal 140 should not access or that the mobile terminal 140 is not permitted to access and transmit the list to the mobile terminal 140 so that the mobile terminal 140 can avoid unnecessary cell selection/reselection.

As another example, aside from the Local IP Access, it is conceivable that the mobile terminal 140 is a device adapted for Machine-to-Machine (M2M). M2M devices such as a security camera or a smart meter are characterized by the fact that the devices are immobile or have a limited mobile range. In such a case, it is conceivable that an M2M device limits accessible base stations and provides an A-PCI list for such base stations. As a way of implementation, it is conceivable that a controller in the network, such as an MME, limits base stations accessible to M2M devices and transmits the result to the mobile terminal 140 as an A-PCI list. As means for transmission at this time, a NAS message may be used, or an RRC message may be used. Instead of messages defined by 3GPP or the like, the use of application programs may be conceivable, or the use of Internet Multimedia System (IMS), such as Session Initiating Protocol (SIP), or the use of OMA DM and the like may be conceivable. In this way, even if the mobile terminal selects another cell due to, for example, degradation of communication quality of the currently connected cell, the mobile terminal is prevented from accessing inaccessible cells, which has an advantage that unnecessary access of the mobile terminal is avoided and the like.

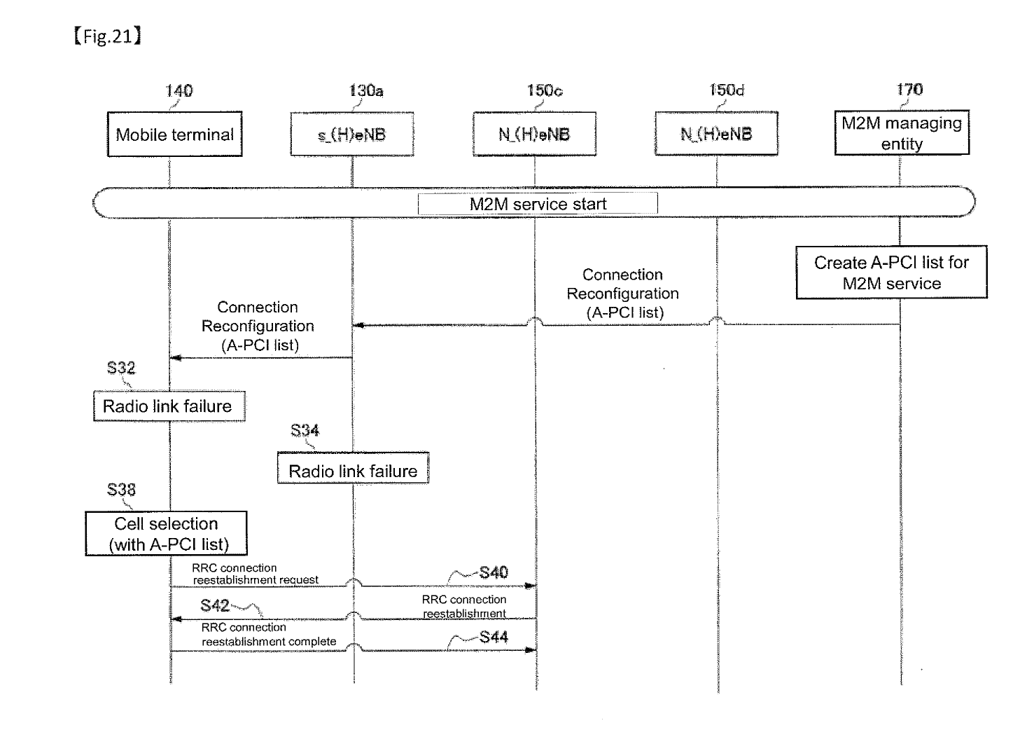

FIG. 21 shows an operational sequence of the operation in the case of M2M. The diagram is based on FIG. 20, and description on similar portions to those in FIG. 20 will be omitted.

The s_HeNB 130, the n_HeNB 150a, and the n_HeNB 150b are replaced with an s_(H)eNB 130a, an n_(H)eNB 150c, and an n_(H)eNB 150d, respectively. This is because, in the case of M2M, an HeNB is not necessarily be needed, and an eNB that provides a macro cell may be an alternative. In addition, the Local IP Access entity 160 is replaced with an M2M managing entity 170, and the M2M managing entity 170 determines which (H)eNBs provide cells that are accessible in order to provide M2M services, and creates an A-PCI list. Similarly to FIG. 20, the M2M managing entity 170 may be implemented in an (H)eNB or an MME.

Information in an A-PCI list may be used when the mobile terminal 140 is not only in an RRC_Connected state but also in an RRC_Idle state, and is valid both when the mobile terminal 140 performs cell selection and when the mobile terminal 140 performs cell reselection. Using information in an A-PCI list when the mobile terminal 140 is in the RRC_Connected state can eliminate unnecessary measurement and reduce power consumption of the mobile terminal 140.

It is to be noted that the above example of a printer can be considered as an M2M service instead of Local IP Access, and is not limited to the use of the HeNB.

It is conceivable that an A-PCI list includes information instead of PCIs. For example, the A-PCI list can include ECGIs or CSG IDs for actually identifying cells. This allows the mobile terminal 140 that has examined a PCI to check broadcast information, check an ECGI or a CSG ID, and check whether the cell is actually that of concern. This can prevent the mobile terminal 140 from requesting services or the like in an incorrect cell. It is also possible to indicate not only additional information but also how the mobile terminal 140 should use the information: for example, examining broadcast information to check in the above example.

It is to be noted that the operation is not limited to that of a printer, and is applicable to any services considered as Local IP Access and M2M.

In creating an A-PCI list, it is conceivable to include M2M subscription information, the location information of the mobile terminal 140, a policy of the operator, a policy of M2M services and the like.

### Seventh Embodiment

In this embodiment, A-PCI list information as described in the sixth embodiment is created for each service and application to be used and is provided to a mobile terminal. As a specific example, in the case of a mobile terminal 140 that has both an M2M function and a function as a regular mobile terminal, it is conceivable that the network creates A-PCI list information for providing M2M services and A-PCI list information for providing Local IP Access services separately, and provides the mobile terminal 140 with the information separately. It is thereby possible to determine accessible cells depending on the service currently used by the mobile terminal 140. Specifically, it is conceivable to use the A-PCI list information for M2M while an M2M service is provided and use the A-PCI list information for Local IP Access while a Local IP Access service is used.

It is conceivable to create different A-PCI lists for each service used in Local IP Access. For an example Local IP Access, it is conceivable to use a printer to print a document. In cases where two or more mobile terminals print a large number of photographs, operation of a printer to allow only mobile terminals located near the printer to print may be useful in order, for example, to reduce the processing load on the printer, to control network resources including a storage, or to avoid selecting an incorrect printer. To that end, it is conceivable to create an A-PCI list in the printer so that only mobile terminals located near the printer (i.e. adjacent cell) are permitted to use the printer. On the other hand, in the case of servers or the like that have videos or the like stored therein, access may be permitted in cells in a wider area. In such a case, different A-PCI lists may be created and transmitted to the respective mobile terminals. In this way, even in the same Local IP Access, A-PCI lists can be selected depending on the services currently used by the mobile terminals to select or preferentially select cells that allow continuation of the use of the services.

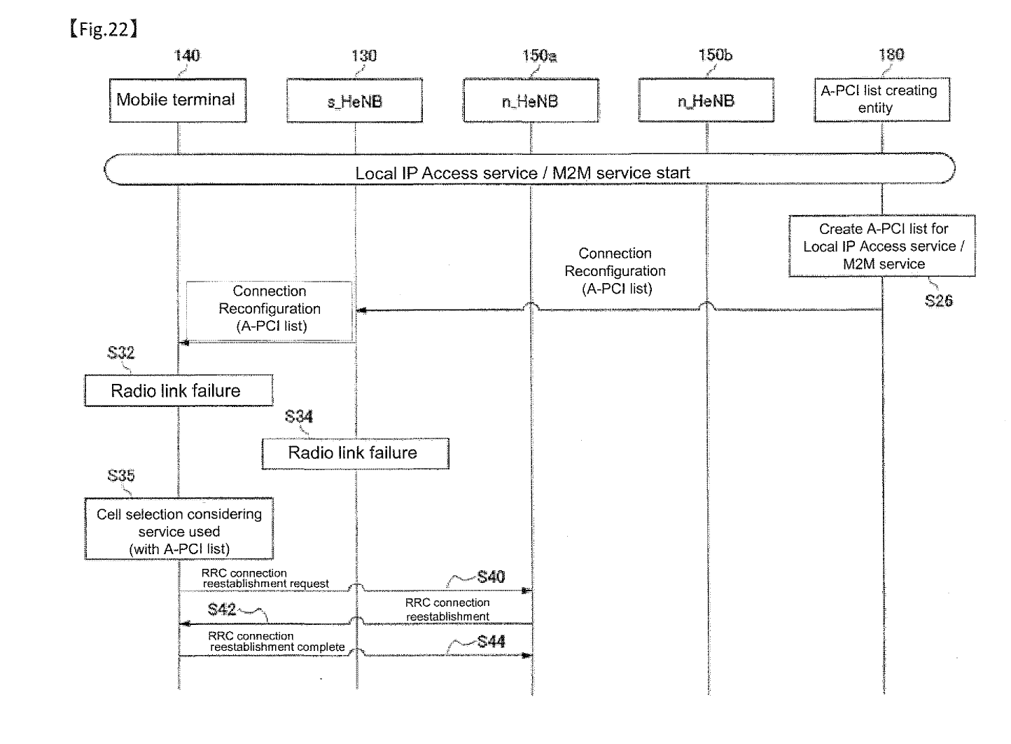

FIG. 22 shows an operational sequence of the operation. The diagram is based on FIG. 20, and description on similar portions to those in FIG. 20 will be omitted.

An A-PCI list creating entity 180 has a function for creating an A-PCI list, and has a function for creating an M2M A-PCI list, a Local IP Access A-PCI list, or an A-PCI list for each specific service of M2M or Local IP Access. Step 26 shows the operation. Although one entity is shown for clarity in this diagram, it is possible for two or more entities to create A-PCI lists and each provide the lists to the mobile terminal 140.

The mobile terminal 140 selects an A-PCI list associated with the service currently used by the mobile terminal 140 from one or more A-PCI lists, and preferentially selects cells in the A-PCI list (S35). When the mobile terminal 140 uses two or more services and more than one A-PCI list is applicable, the mobile terminal 140 may operate to give priority to cells found in all applicable A-PCI lists or to preferentially use an A-PCI list corresponding to a higher priority service,

In this embodiment, the network transmits two or more A-PCI lists to mobile terminals 140 and the mobile terminals 140 determine an A-PCI list to use. However, the network may instead select an A-PCI list to be transmitted to a mobile terminal 140 based on the service used by the mobile terminal 140. In this case, the mobile terminal 140 can use the A-PCI list regardless of whatever the service is used by the mobile terminal 140. In this case, an A-PCI list to be transmitted is selected in step S26 in FIG. 22, and step 35 is replaced with a similar operation to that in FIG. 20.

### Eighth Embodiment

In this embodiment, description will be made to an example in which information from a mobile terminal is used to restrict creation of multiple-A-PCI list information as described in the previous embodiment.

A mobile terminal 140 may not need A-PCI list information for Local IP Access when, for example, the mobile terminal 140 is not using a Local IP Access service. In such a case, it is conceivable to inhibit transmission of Local IP Access A-PCI list information to the mobile terminal 140.

As a way of implementation, it is conceivable that the mobile terminal 140 provides lists needed by the mobile terminal 140 to the network. As notification, NAS messages such as Service Request and Tracking Area Update may be used. As notification, a predetermined flag may also be used, or Evolved Packet Service (EPS) bearer, with which a service to be used can be determined, may be used.

The network receives these signals from the mobile terminal 140, creates A-PCI list information needed by the mobile terminal 140, and transmits the information to the mobile terminal 140. This can reduce processing for creating A-PCI list information on the network side and can reduce the message size and the like.

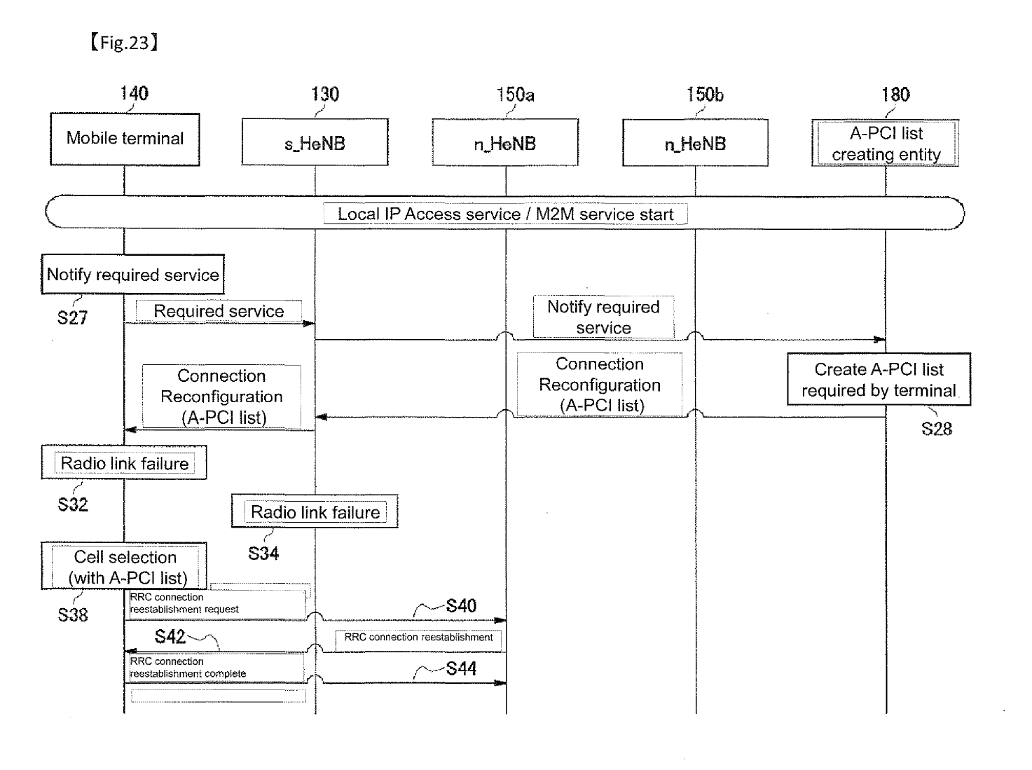

FIG. 23 shows an operational sequence of the operation in this case. The diagram is based on FIG. 20, and description on similar portions to those in FIG. 20 will be omitted.

In step S27, the mobile terminal 140 determines a required service based on the service currently used by the mobile terminal 140. The mobile terminal 140 then transmits information indicative of the determined service to the A-PCI list creating entity 180.

The A-PCI list creating entity 180 creates a required A-PCI list based on the indication from the mobile terminal 140 (S28). The A-PCI list creating entity 180 transmits the created A-PCI list to the mobile terminal 140. In this way, only a required A-PCI list is provided to the mobile terminal 140.

### Ninth Embodiment

Unlike the above embodiments, this embodiment is characterized by A-PCI lists that are used in other operation than cell selection and cell reselection.

As indicated in the sixth embodiment, A-PCI lists may be applicable to M2M services. In such a case, it is possible to invoke a specific operation at the same time as cell detection. Specifically, this may be applicable to printing with a printer as indicated in the sixth embodiment. For example, even when a user indicates printing with a printer, the mobile terminal 140 may not be included in a cell in which a printer is available. In such a case, it is conceivable to temporarily retain a request for printing with a printer in the mobile terminal 140, and to notify the user that the user is near a cell in which a printer is available when a cell included in an A-PCI list is detected.

The operation may be initiated not only when the mobile terminal 140 detects an A-PCI list but also when the mobile terminal 140 enters a cell included in an A-PCI list. In this case, it is conceivable to temporarily retain a request for printing with a printer in the mobile terminal 140, and to automatically initiate the operation when the mobile terminal 140 enters a cell included in an A-PCI list. In order to facilitate such an action of the mobile terminal 140, the mobile terminal 140 may operate to preferentially connect to cells included in an A-PCI list.

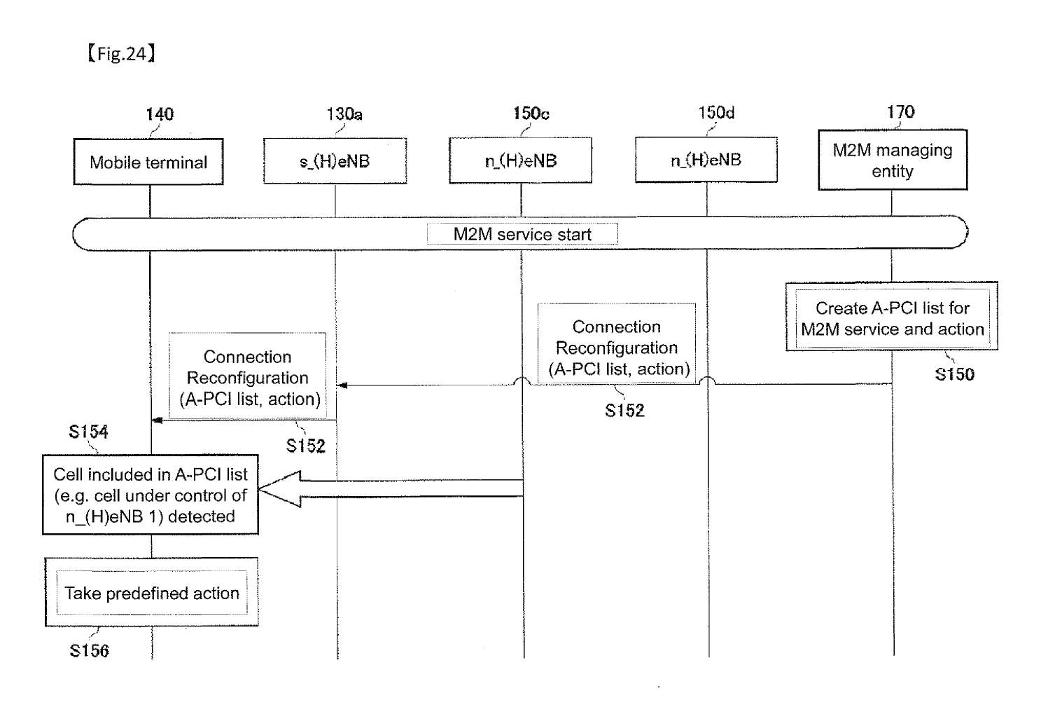

FIG. 24 shows an operational sequence of the operation of the embodiment. The diagram is based on FIG. 21, and description on similar portions to those in FIG. 21 will be omitted.

In addition to creating the above-mentioned A-PCI list, the M2M managing entity 170 determines an action to be taken by the mobile terminal 140 when the mobile terminal 140 detects a cell included in an A-PCI list, and creates information thereof (S150). In the above example, the action is, for example, to notify that a cell in which a printer is available has been detected. In addition to the above-mentioned A-PCI list, the M2M managing entity 170 then transmits information of the action to be taken by the mobile terminal 140 created in step S150 to the mobile terminal 140 (S152). The mobile terminal 140 detects a cell included in the A-PCI list (S154). FIG. 24 shows the case where a cell that is under control of an n_(H)eNB 1 is detected. The mobile terminal 140 takes the action specified in step S152 in response to the cell detected in step S154. In this way, A-PCI lists may be used in other operation than cell selection and cell reselection.

The operation in the embodiment may also be used when the terminal is not only in an RRC_Connected state but also in an RRC_Idle state.

In addition to PCIs, A-PCI list information may include ECGIs and CSG IDs. In this way, when the mobile terminal 140 connects to a cell included in an A-PCI list, the mobile terminal 140 checks an ECGI or a CSG ID in broadcast information to reliably confirm that the cell can provide a service.

Instead of A-PCI lists, only cell related information such as ECGIs or CSG IDs may be used as cell information. Additionally, to notify the mobile terminal 140 of the cell information, it is conceivable to use not only RRC messages but also NAS messages, messages by means of application programs, and the like. Furthermore, when messages by means of application programs are used, information is required whether or not a cell compatible with the application program is located nearby. It is therefore conceivable to use RRC or NAS to uninterruptedly notify information about the currently connected cell or adjacent cells, or it is alternatively conceivable to cause the application program to pass information about applicable cells to RRC or NAS, which in turn sends information about the cells when the cells are detected or a connection is made with any of the cells.

Although preferred embodiments of the present invention conceivable at this time have been described, various modifications may be made to the embodiments and the attached claims are intended to encompass all such modifications that fall within the scope and true spirit of the invention.

### INDUSTRIAL APPLICABILITY

The present invention has an advantage that a mobile terminal can immediately be connected to a CSG cell that the mobile terminal is permitted to access, and is useful for a base station controller or the like that controls recovery connection or handover processing.

### REFERENCE SIGNS LIST

100 Mobile communication system
110 MME
120 HeNB-GW
130 s_HeNB
140 Mobile terminal
150 t_HeNB
310 CSG list managing section
320 Mobility managing section
410 HeNB managing section
412 Location information acquiring section
420 PCI mapping section
425 Access-permitted CSG-ID list storing section
430 HeNB information storing section
502 PCI list managing section
506 Recovery connection section
510 Connection establishing section
512 Priority determining section
600 Mobile communication system
610 MME
620 s_HeNB
630 Mobile terminal
640 t_HeNB
810 CSG-ID managing section
820 PCI mapping section
830 Mobility managing section
835 Location information receiving section
840 HeNB information storing section
845 Access-permitted CSG-ID list storing section

1. A base station controller applied to a network that comprises a plurality of CSG cells, the base station controller comprising:
an access permission information storing section having a CSG identification of a CSG cell that a mobile terminal is permitted to access stored therein with the identification associated with the mobile terminal;
a CSG cell information storing section having a physical cell ID corresponding to the CSG cell identification stored therein;
a location information receiving section for receiving information identifying a CSG cell in which the mobile terminal is located;
a mapping section that reads at least one CSG cell accessible to the mobile terminal from the access permission information storing section, reads, from the CSG cell information storing section, a physical cell ID of an adjacent CSG cell among the read CSG cells within a predetermined range of the CSG cell in which the mobile terminal is present, and generates an accessible physical cell ID list to the mobile terminal; and
a notification section for providing the mobile terminal with the accessible physical cell ID list.

2. The base station controller according to claim 1, wherein the accessible physical cell ID list is provided to the mobile terminal by means of a dedicated channel.

3. The base station controller according to claim 1, wherein the mapping section adds information indicative of whether or not an adjacent CSG cell has context information of the mobile terminal to the accessible physical cell ID list.

4. The base station controller according to claim 1, wherein broadcast information is used to transmit an accessible physical cell ID list common to mobile terminals present in a CSG cell.

5. The base station controller according to claim 4, wherein broadcast information is used to transmit the common accessible physical cell ID list along with information identifying whether the physical cell ID list is valid.

6. A mobile terminal comprising:
a storage section having a physical cell ID list of accessible CSG cells stored therein; and
a priority determining section that reads an accessible physical cell ID list from the storage section and determines priorities of cell selection by the use of the read physical cell ID list.

7. The mobile terminal according to claim 6, wherein the storage section has stored therein a physical cell ID list of CSG cells that is accessible to a mobile terminal and has context information of the mobile terminal stored therein.

8. The mobile terminal according to claim 6, further comprising a reception section for receiving a physical cell ID list of accessible CSG cells in broadcast information,
wherein the received physical cell ID list is stored in the storage section.

9. The mobile terminal according to claim 6, wherein the priority determining section determines priorities in cell reselection when a connection is to be recovered with a base station in a CSG cell.

10. The mobile terminal according to claim 6, wherein the priority determining section determines priorities in cell selection for a handover destination.

11. The mobile terminal according to claim 10, wherein information indicative of cell priorities determined by the priority determining section is transmitted to a base station during handover.

12. A base station controlling method by a base station controller applied to a network that comprises a plurality of CSG cells, the method comprising:
receiving, by the base station controller, information identifying a CSG cell in which the mobile terminal is located;
reading at least one CSG cell accessible to the mobile terminal from an access permission information storing section having a CSG identification of a CSG cell that a mobile terminal is permitted to access stored therein with the identification associated with the mobile terminal;
reading, by the base station controller, a physical cell ID of an adjacent CSG cell among the read CSG cells within a predetermined range of the CSG cell in which the mobile terminal is present from a CSG cell information storing section having a physical cell ID corresponding to the CSG cell identification stored therein, and generating an accessible physical cell ID list to the mobile terminal; and
providing the mobile terminal with the accessible physical cell ID list.

13. A cell selection method by a mobile terminal applied to a network that comprises a plurality of CSG cells, the method comprising:
receiving, by the mobile terminal, a physical cell ID list of accessible CSG cells, and storing the received physical cell ID list in a storage section;
reading, by the mobile terminal, the accessible physical cell ID list from the storage section; and
determining, by the mobile terminal, priorities of cell selection by the use of the read physical cell ID list.
